(19) United States
(12) Patent Application Publication
(10) Pub. No.: US 2012/0120121 A1
(43) Pub. Date: May 17, 2012

(54) IMAGE DISPLAY APPARATUS AND METHOD OF DRIVING IMAGE DISPLAY APPARATUS

(75) Inventors: Tetsuyuki Yoshida, Tokyo (JP); Yoshihisa Sato, Saitama (JP); Yoshiki Okamoto, Kanagawa (JP); Sho Sakamoto, Tokyo (JP); Atsuhiro Chiba, Tokyo (JP)

(73) Assignee: SONY CORPORATION, Tokyo (JP)

(21) Appl. No.: 13/287,729

(22) Filed: Nov. 2, 2011

(30) Foreign Application Priority Data
Nov. 15, 2010 (JP) 2010-254430

(51) Int. Cl. G09G 5/10; G09G 3/36

(52) U.S. Cl. 345/690; 345/102

(57) ABSTRACT

Disclosed herein is an image display apparatus including: a transmissive display panel; an illuminator configured to illuminate a rear surface of the transmissive display panel; an optical separator which includes a plurality of switchers capable of switching between a light transmitting state and a light blocking state, for separating an image displayed on the transmissive display panel by bringing one of the switchers into the light transmitting state and the other switchers into the light blocking state; and a light regulator capable of switching between a light diffusing state and a light transmitting state.

### BACKGROUND

The present disclosure relates to an image display apparatus and a method of driving an image display apparatus, and more particularly to an image display apparatus which is capable of switching between the display of stereoscopic images and the display of ordinary images such as planar images, and a method of driving such an image display apparatus.

Heretofore, there are known various image display apparatus for realizing stereoscopic vision when an image observer observes two disparity images. The image display apparatus are generally classified into an anaglyph glass type wherein disparity images are separately applied to the left and right eyes of the image observer through anaglyph glasses and a naked eye type (glasses-free type) wherein disparity images are applied to the left and right eyes of the image observer not through anaglyph glasses.

Naked-eye-type image display apparatus which efforts have been made to put to practical use include a lenticular image display apparatus made up of an image display (two-dimensional image display) and a lenticular lens in combination, and a parallax-barrier image display apparatus made up of an image display and a parallax barrier (disparity barrier).

The parallax-barrier image display apparatus usually includes an image display in the form of a display panel having a two-dimensional matrix of pixels arranged horizontally along horizontal rows and vertically along vertical columns, and a parallax barrier having light blocking portions and light transmitting portions in the form of vertical slits.

For example, Japanese Patent Laid-open No. Hei 5-122733 discloses a parallax barrier that is provided by displaying a barrier stripe on a liquid crystal display panel. Parallax-barrier image display apparatus are roughly divided into an image display apparatus wherein a parallax barrier is positioned between an image display and an image observer (hereinafter referred to as “front-barrier image display apparatus”) and an image display apparatus having an image display in the form of a transmissive display panel such as a transmissive liquid crystal display panel or the like and an illuminator, with a parallax barrier being positioned between the transmissive display panel and the illuminator (hereinafter referred to as “rear-barrier image display apparatus”).

FIG. 30A of the accompanying drawings is a conceptual diagram of a front-barrier image display apparatus, and FIG. 30B of the accompanying drawings is a conceptual diagram of a rear-barrier image display apparatus.

As shown in FIG. 30A, in the front-barrier image display apparatus, a group of light rays emitted from a group of pixels L2, L4, L6, L8, L10 travel through the light transmitting portions of the parallax barrier to a first viewpoint DL, and a group of light rays emitted from a group of pixels R1, R3, R5, R7, R9 travel through the light transmitting portions of the parallax barrier to a second viewpoint DR. The paths of light rays which are blocked by the light blocking portions of the parallax barrier are indicated by the broken lines.

As shown in FIG. 30B, in the rear-barrier image display apparatus, a group of light rays emitted from the illuminator and passing through the light transmitting portions of the parallax barrier are transmitted through a group of pixels L2, L4, L6, L8, L10 to a first viewpoint DL, and a group of light rays emitted from the illuminator and passing through the light transmitting portions of the parallax barrier are transmitted through a group of pixels R1, R3, R5, R7, R9 to a second viewpoint DR. The paths of light rays which are blocked by the light blocking portions of the parallax barrier are indicated by the broken lines.

In FIGS. 30A and 30B, it is assumed that the image observer has a left eye located at the first viewpoint DL and a right eye located at the second viewpoint DR. When the image display apparatus displays a left-eye image with the group of pixels L2, L4, L6, L8, L10 and at the same time displays a right-eye image with the group of pixels R1, R3, R5, R7, R9, the image observer observes the displayed images as a combined stereoscopic image.

The front-barrier image display apparatus tends to make the image observer find the parallax barrier visually obtrusive when the image observer observes displayed images because the parallax barrier is positioned on the observer's side of the image display. However, the rear-barrier image display apparatus does not make the image observer find the parallax barrier visually obtrusive because the image observer directly observes images displayed by the transmissive display panel.

There is a rear-barrier image display apparatus which incorporates a parallax barrier having an optical separator that is capable of switching between a light blocking state and a light transmitting state. Such a rear-barrier image display apparatus is advantageous in that the parallax barrier is not visually obtrusive and it can switch between the display of stereoscopic images and the display of ordinary images such as planar images depending on signals representative of images to be displayed. Specifically, when a stereoscopic image is to be displayed, the optical separator is switched into the light blocking state to activate the parallax barrier, and when an ordinary image is to be displayed, all the areas of the optical separator are switched into the light transmitting state. The rear-barrier image display apparatus thus arranged does not make the parallax barrier visually obtrusive and is capable of switching between the display of stereoscopic images and the display of ordinary images depending on signals representative of images to be displayed.

### SUMMARY

With the rear-barrier image display apparatus which incorporates the parallax barrier having the optical separator, all the areas of the optical separator are switched into the light transmitting state for displaying ordinary images. The optical separator includes a liquid crystal material layer. Depending on the relationship between the direction of orientation of liquid crystal molecules of the liquid crystal material layer and the viewpoints of the image observer, the colors and luminance of the light from the illuminator which passes through the optical separator may change, tending to cause color irregularities and luminance irregularities in displayed ordinary images.

Accordingly, it is desirable to provide an image display apparatus and a method of driving an image display apparatus, which are capable of switching between the display of stereoscopic images and the display of ordinary images depending on signals representative of images to be displayed, and of reducing color irregularities and luminance irregularities in displayed ordinary images.

According to an embodiment of the present disclosure, there is provided an image display apparatus including:

a transmissive display panel;

an illuminator for illuminating a rear surface of the transmissive display panel;
an optical separator which includes a plurality of switchers capable of switching between a light transmitting state and a light blocking state, for separating an image displayed on the transmissive display panel by bringing one of the switchers into the light transmitting state and the other switchers into the light blocking state; and
a light regulator capable of switching between a light diffusing state and a light transmitting state.

In the image display apparatus, the optical separator is disposed between the transmissive display panel and the illuminator;

the light regulator is disposed between the optical separator and the transmissive display panel;

when a plurality of viewpoint images are displayed on the transmissive display panel, the light regulator is brought into the light transmitting state; and
when a single viewpoint image is displayed on the transmissive display panel, the light regulator is brought into the light diffusing state.

According to another embodiment of the present disclosure, there is also provided a method of driving an image display apparatus. The image display apparatus includes:

a transmissive display panel;

an illuminator for illuminating a rear surface of the transmissive display panel;

an optical separator which includes a plurality of switchers capable of switching between a light transmitting state and a light blocking state, for separating an image displayed on the transmissive display panel by bringing one of the switchers into the light transmitting state and the other switchers into the light blocking state; and

a light regulator capable of switching between a light diffusing state and a light transmitting state.

In the image display apparatus, the optical separator is disposed between the transmissive display panel and the illuminator; and

the light regulator is disposed between the optical separator and the transmissive display panel.

The method includes:

bringing the light regulator into the light transmitting state when a plurality of viewpoint images are displayed on the transmissive display panel; and

bringing the light regulator into the light diffusing state when a single viewpoint image is displayed on the transmissive display panel.

With the image display apparatus according to the present disclosure, the light regulator capable of switching between a light diffusing state and a light transmitting state is disposed between the optical separator and the transmissive display panel. When the light regulator is in the light transmitting state and the optical separator forms a parallax barrier, the image display apparatus can display a stereoscopic image without any problems. When the image display apparatus displays an ordinary image while the light regulator is in the light diffusing state and all areas of the optical separator are in the light transmitting state, color and luminance changes in the light emitted from the illuminator and passing through the optical separator are less liable to be visually recognized. The image display apparatus and the method of driving the image display apparatus according to the present disclosure are thus capable of reducing color irregularities and luminance irregularities in displayed ordinary images.

### BRIEF DESCRIPTION OF THE DRAWINGS

FIG. 1 is a conceptual view of an image display apparatus according to Embodiment 1 of the present disclosure;

FIG. 2 is a schematic exploded perspective view of the image display apparatus according to Embodiment 1;

FIG. 3 is a fragmentary schematic end view of the image display apparatus according to Embodiment 1, showing the layout of a transmissive display panel, a light regulator, an optical separator, and an illuminator of the image display apparatus;

FIG. 4 is a fragmentary schematic cross-sectional view of the optical separator at the time first switchers, second switchers, and third switchers are in a light transmitting state;

FIG. 5 is a schematic front elevational view of the optical separator at the time the first switchers, the second switchers, and the third switchers are in the light transmitting state;

FIG. 6 is a fragmentary schematic cross-sectional view of the optical separator at the time the first switchers are in the light transmitting state and the second switchers and the third switchers are in a light blocking state;

FIG. 7 is a schematic front elevational view of the optical separator at the time the first switchers are in the light transmitting state and the second switchers and the third switchers are in the light blocking state;

FIG. 8 is a fragmentary schematic cross-sectional view of the optical separator at the time the second switchers are in the light transmitting state and the first switchers and the third switchers are in the light blocking state;

FIG. 9 is a schematic front elevational view of the optical separator at the time the second switchers are in the light transmitting state and the first switchers and the third switchers are in the light blocking state;

FIG. 10 is a fragmentary schematic cross-sectional view of the light regulator;

FIG. 11A is a schematic front elevational view illustrative of the light regulator whose light regulating surface is in the light transmitting state, and FIG. 11B is a schematic front elevational view illustrative of the light regulator whose light regulating surface is in a light diffusing state;

FIG. 12 is a schematic plan view showing the layout of viewpoints D1, D2, D3, D4 in observational areas, the transmissive display panel, and the first switchers, the second switchers, and the third switchers of the optical separator shown in FIG. 1;

FIG. 13 is a schematic plan view illustrative of conditions to be met for light from a pixel to travel to the viewpoints D1, D2, D3, D4 in the central observational area;

FIG. 14 is a schematic plan view illustrative of conditions to be met for light from a pixel to travel to the viewpoints D1, D2, D3, D4 in the left observational area;

FIG. 15 is a fragmentary schematic plan view of the optical separator and a display area, showing the layout of pixels, and the first switchers, the second switchers, and the third switchers of the optical separator of the image display apparatus according to Embodiment 1;

FIG. 16A is a schematic front elevational view illustrative of a state of the optical separator for displaying an ordinary image, and FIG. 16B is a schematic front elevational view illustrative of a state of the light regulator for displaying an ordinary image;

FIG. 17 is a schematic plan view illustrative of a state for displaying an ordinary image;

FIG. 18A is a schematic front elevational view illustrative of a state of the optical separator for displaying a stereoscopic image, and FIG. 18B is a schematic front elevational view illustrative of a state of the light regulator for displaying a stereoscopic image;

FIG. 19A is a schematic front elevational view illustrative of a state of the optical separator for displaying a stereoscopic image, and FIG. 19B is a schematic front elevational view illustrative of a state of the light regulator for displaying a stereoscopic image;

FIG. 20 is a schematic plan view illustrative of images that are observed at the viewpoints D1, D2, D3, D4 in the central observational area at the time the second switchers are in the light transmitting state and the first switchers and the third switchers are in the light blocking state;

FIG. 21 is a schematic plan view illustrative of images that are observed at the viewpoints D1, D2, D3, D4 in the left observational area at the time the second switchers are in the light transmitting state and the first switchers and the third switchers are in the light blocking state;

FIG. 22 is a schematic plan view illustrative of images that are observed at the viewpoints D1, D2, D3, D4 in the right observational area at the time the second switchers are in the light transmitting state and the first switchers and the third switchers are in the light blocking state;

FIG. 23 is a schematic plan view illustrative of images that are observed at the viewpoints D1, D2, D3, D4 in the central observational area at the time the first switchers are in the light transmitting state and the second switchers and the third switchers are in the light blocking state;

FIG. 24 is a schematic plan view illustrative of images that are observed at the viewpoints D1, D2, D3, D4 in the left observational area at the time the first switchers are in the light transmitting state and the second switchers and the third switchers are in the light blocking state;

FIG. 25 is a schematic plan view illustrative of images that are observed at the viewpoints D1, D2, D3, D4 in the right observational area at the time the first switchers are in the light transmitting state and the second switchers and the third switchers are in the light blocking state;

FIG. 26A is a table of column numbers of pixels that make up the images at the viewpoints D1, D2, D3, D4 in the observational areas at the time the second switchers are in the light transmitting state and the first switchers and the third switchers are in the light blocking state, and column numbers of pixels that make up the images at the viewpoints D1, D2, D3, D4 in the observational areas at the time the first switchers are in the light transmitting state and the second switchers and the third switchers are in the light blocking state, in the image display apparatus according to Embodiment 1, and FIG. 26B is a table which is complied from the table shown in FIG. 26A;

FIG. 27 is a fragmentary schematic plan view of the optical separator and the display area, showing the layout of pixels, and the first switchers, the second switchers, and the third switchers of the optical separator of the image display apparatus according to Embodiment 1;

FIG. 28 is a schematic exploded perspective view of an image display apparatus according to a modification of the present disclosure;

FIG. 29 is a schematic exploded perspective view of an image display apparatus according to another modification of the present disclosure; and

FIG. 30A is a conceptual view of a front-barrier image display apparatus, and FIG. 30B is a conceptual view of a rear-barrier image display apparatus.

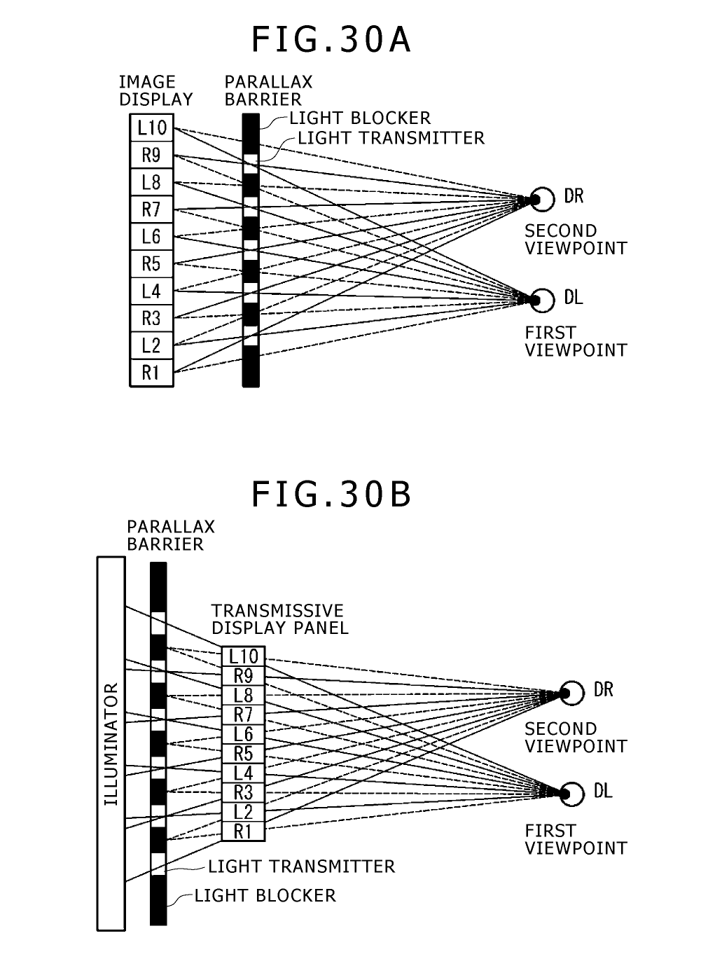

### DETAILED DESCRIPTION OF THE PREFERRED EMBODIMENT

Preferred embodiment of the present disclosure will be described in detail below with reference to the drawings. However, the present disclosure is not limited to the preferred embodiments, and various numerical values and materials referred to in the preferred embodiments are given by way of example only. The present disclosure will be described according to the following sequence:

1. General nature of an image display apparatus and a method of driving an image display apparatus according to the present disclosure

2. Embodiment 1

### [General Nature of an Image Display Apparatus and a Method of Driving an Image Display Apparatus According to the Present Disclosure]

An image display apparatus according to the present disclosure and an image display apparatus which is driven by a method of driving an image display apparatus according to the present disclosure (hereinafter simply referred to as “image display apparatus according to the present disclosure”) should preferably include, as a light regulator, a member for electrically switching between a light transmitting state and a light diffusing state.

The member for electrically switching between the light transmitting state and the light diffusing state should preferably be in the form of a panel including a diffused liquid crystal material layer which switches between a light transmitting state and a light diffusing state depending on a voltage applied thereto. For example, a panel including a pair of light transmissive support bodies each having a transparent electrode and a diffused liquid crystal material layer disposed therebetween may be used as a light regulator. The diffused liquid crystal material layer is made of a diffused liquid crystal material known in the art which may be a polymer dispersed liquid crystal (PDLC) or a polymer network liquid crystal (PNLC). The diffused liquid crystal material is capable of switching between a state in which the refractive indexes of a liquid crystal region and a polymer material region are substantially equal to each other (light transmitting state) and a state in which the refractive indexes of the liquid crystal region and the polymer material region are different from each other (light diffusing state (turbid state)), by changing the direction of orientation of liquid crystal molecules. Therefore, the panel including the pair of light transmissive support bodies each having the transparent electrode and the diffused liquid crystal material layer disposed therebetween is capable of switching between two states, i.e., the light diffusing state and the light transmitting state, by controlling a voltage applied to the transparent electrodes. The light transmissive support bodies may be made of any of various known transparent materials including glass, plastic, etc. The light transmissive support bodies may be in the form of a sheet or a film. The transparent electrodes may be made of indium tin oxide (ITO). Generally, the PDLC is brought into the light transmitting state when a voltage is applied between the transparent electrodes, and is brought into the light diffusing state when a voltage stops being applied between the transparent electrodes. However, the PDLC is not limited to such a mode of operation.

The image display apparatus according to the present disclosure should preferably bring all switchers of an optical separator into the light transmitting state when a single viewpoint image is displayed on the transmissive display panel. Similarly, the method of driving the image display apparatus according to the present disclosure should preferably bring all the switchers of the optical separator into the light transmitting state when a single viewpoint image is displayed on the transmissive display panel. Since the amount of light that is transmitted through the optical separator is maximized, the image display apparatus can display ordinary images of high luminance.

The optical separator may be fabricated of any of various known materials according to a known fabrication process. The optical separator is not limited to any materials, and a liquid crystal material layer thereof is not limited to any modes of operation. The material of the optical separator and the mode of operation of the liquid crystal material layer thereof may be selected depending on the arrangement of the optical separator. For example, the liquid crystal material layer may be made of a ferroelectric liquid crystal material for an increased response of the switchers of the optical separator. In some cases, a liquid crystal display panel for monochromatic display may be used as the optical separator.

With the image display apparatus according to the present disclosure, the switchers of the optical separator include a plurality of first switchers, second switchers, and third switchers which extend substantially vertically and which are juxtaposed horizontally, and the first switchers and the second switchers are alternately disposed horizontally with the third switchers interposed therebetween. When the image display apparatus according to the present disclosure displays a plurality of viewpoint images on the transmissive display panel, or stated otherwise, displays a stereoscopic image, the optical separator switches alternately between a state in which the first switchers are in the light transmitting state and the second switchers and the third switchers are in the light blocking state, and a state in which the second switchers are in the light transmitting state and the first switchers and the third switchers are in the light blocking state, and the transmissive display panel synchronously switches between images displayed thereon. Similarly, when a plurality of viewpoint images are displayed on the transmissive display panel, the method of driving the image display apparatus according to the present disclosure switches alternately between a state in which the first switchers are in the light transmitting state and the second switchers and the third switchers are in the light blocking state, and a state in which the second switchers are in the light transmitting state and the first switchers and the third switchers are in the light blocking state, and also synchronously switches between images displayed on the transmissive display panel. With the above arrangement, light is emitted from pixels toward different viewpoints when the first switchers are in the light transmitting state and when the second switchers are in the light transmitting state. Since the transmissive display panel synchronously switches between images displayed thereon, a reduction in the resolution of the viewpoint images is lowered.

As described above, the switchers of the optical separator may extend substantially vertically. Switchers which extend in an angular range from 60 degrees to 90 degrees with respect to the horizontal direction are covered by the switchers of the optical separator that extend substantially vertically.

The image display apparatus according to the present disclosure including various preferred arrangement details may incorporate a known transmissive display panel such as a liquid crystal display panel or the like. The transmissive display panel is not limited to any structures and types. The transmissive display panel may be a monochromatic display panel or a color display panel. The transmissive display panel may be of a simple matrix display panel or an active matrix display panel. In the embodiments to be described later, an active matrix liquid crystal display panel is used as the transmissive display panel.

The liquid crystal display panel includes a front panel having a transparent first electrode, a rear panel with transparent second electrodes, and a liquid crystal material layer disposed between the front panel and the rear panel. The liquid crystal display panel is not limited to any particular mode of operation. The liquid crystal display panel may be driven in a so-called TN (Twisted Nematic) mode or a VA (Vertical Alignment) mode or an IPS (In-Plane Switching) mode.

More specifically, the front panel includes a first substrate in the form of a glass substrate, a transparent first electrode (also called a common electrode, which is made of ITO, for example) disposed on an inner surface of the first substrate, and polarizer films disposed on an outer surface of the first substrate. The front panel also includes color filters disposed on the inner surface of the first substrate and covered with an overcoat layer made of acrylic resin or epoxy resin, with the transparent first electrode being disposed on the overcoat layer. An orientation film is disposed on the transparent first electrode. The color filters may be arranged in a delta pattern, a striped pattern, a diagonal pattern, or a rectangular pattern.

The rear panel includes a second substrate in the form of a glass substrate, switching devices disposed on an inner surface of the second substrate, transparent second electrodes (also called pixel electrodes, which are made of ITO, for example) which are selectively rendered conductive and nonconductive by the switching devices, and polarizer films disposed on an outer surface of the second substrate. An orientation film is disposed on the entire surface including the transparent second electrodes. The various components and liquid crystal material of the transmissive liquid crystal display panel are of known nature. The switching devices may be three-terminal devices such as thin-film transistors (TFT) or two-terminal devices such as metal insulator metal (MIM) devices, varistor devices, diodes, or the like, for example.

In the color liquid crystal display panel, a region where the transparent first electrode and one of the transparent second electrodes overlap each other and which includes a liquid crystal cell correspond to one auxiliary pixel (subpixel). Of each pixel, a red light-emitting auxiliary pixel is made up of a combination of such a region and a color filter which passes red light therethrough, a green light-emitting auxiliary pixel is made up of a combination of such a region and a color filter which passes green light therethrough, and a blue light-emitting auxiliary pixel is made up of a combination of such a region and a color filter which passes blue light therethrough. Red light-emitting auxiliary pixels, green light-emitting auxiliary pixels, and blue light-emitting auxiliary pixels are arranged in a pattern which is the same as the pattern of the color filters.

The three auxiliary pixels referred to above, which make up each pixel, may be combined one or more auxiliary pixels to provide a set of auxiliary pixels, e.g., a set of auxiliary pixels including an auxiliary pixel for emitting white light to increase luminance in addition to the three auxiliary pixels referred to above, a set of auxiliary pixels including an auxiliary pixel for emitting complementary color light for enlarging a color reproduction range in addition to the three auxiliary pixels referred to above, a set of auxiliary pixels including an auxiliary pixel for emitting yellow light for enlarging a color reproduction range in addition to the three auxiliary pixels referred to above, or a set of auxiliary pixels including auxiliary pixels for emitting yellow light and cyan light for enlarging a color reproduction range in addition to the three auxiliary pixels referred to above.

The color liquid crystal display panel includes a two-dimensional matrix of M×N pixels. The resolution of the color liquid crystal display panel is represented by (M, N) which may be of, but should not be limited to, any of various values including VGA (640, 480), S-VGA (800, 600), XGA (1024, 768), APRC (1152, 900), S-XGA (1280, 1024), U-XGA (1600, 1200), HD-TV (1920, 1080), and Q-XGA (2048, 1536), or any of various values including (1920, 1035), (720, 480), (1280, 960), etc.

The transmissive display panel is illuminated from behind by an illuminator, which may be any of various known illuminators and not be limited to any particular construction. Generally, the illuminator is assembled of known components including a light source, prism sheets, diffusive sheets, light guides, etc.

The transmissive display panel, the optical separator, and the light regulator are driven by a driver including various circuits, e.g., an image signal processor, a timing controller, an image memory, a data driver, a gate driver, and a light regulator controller. These circuits may be made up of known circuit components. The number of sets of stereoscopic image information sent as an electric signal to the driver per second is referred to as a frame frequency (frame rate), and the reciprocal of the frame frequency is a frame time expressed in terms of seconds.

When 60 stereoscopic images are displayed on the transmissive display panel per second, for example, the frame frequency is of 60 hertz. When two images (a first field image and a second field image) are successively displayed on the transmissive display panel in order to display a single stereoscopic image, the so-called field frequency is twice the frame frequency, i.e., 120 hertz.

Various conditions indicated in the present disclosure may be satisfied both strictly and substantially. In other words, various design and manufacturing variations of the image display apparatus according to the present disclosure should be tolerable within the scope of the present disclosure.

### Embodiment 1

Embodiment 1 is concerned with an image display apparatus and a method of driving an image display apparatus according to the present disclosure.

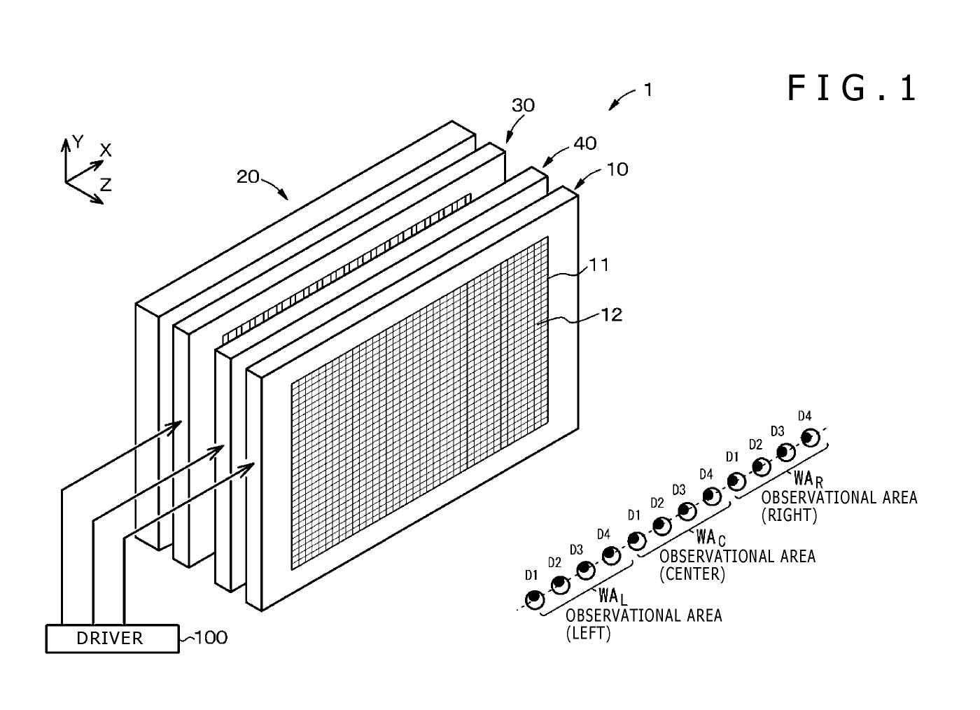

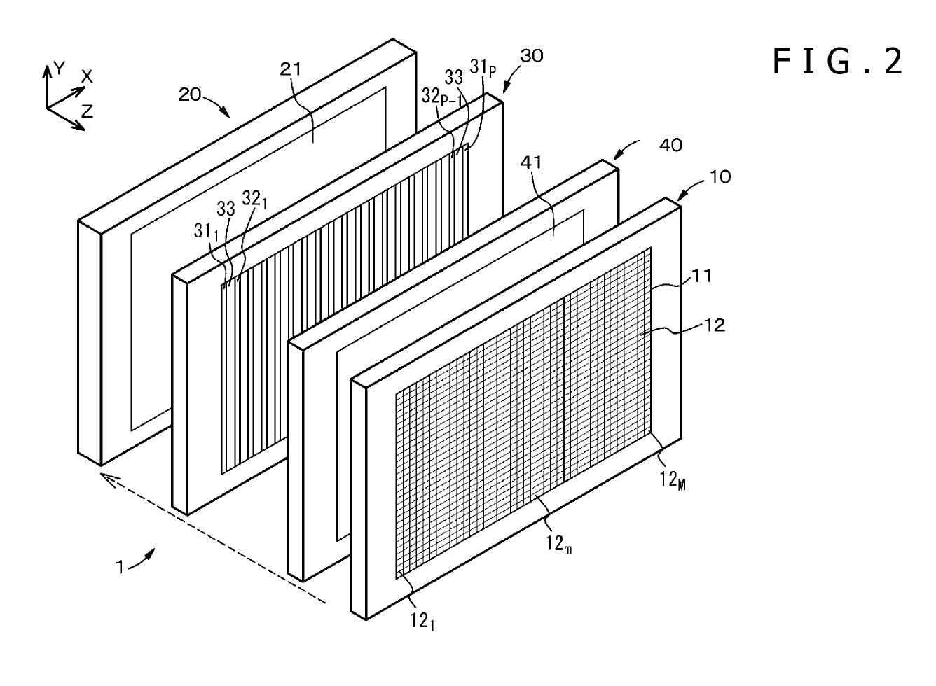

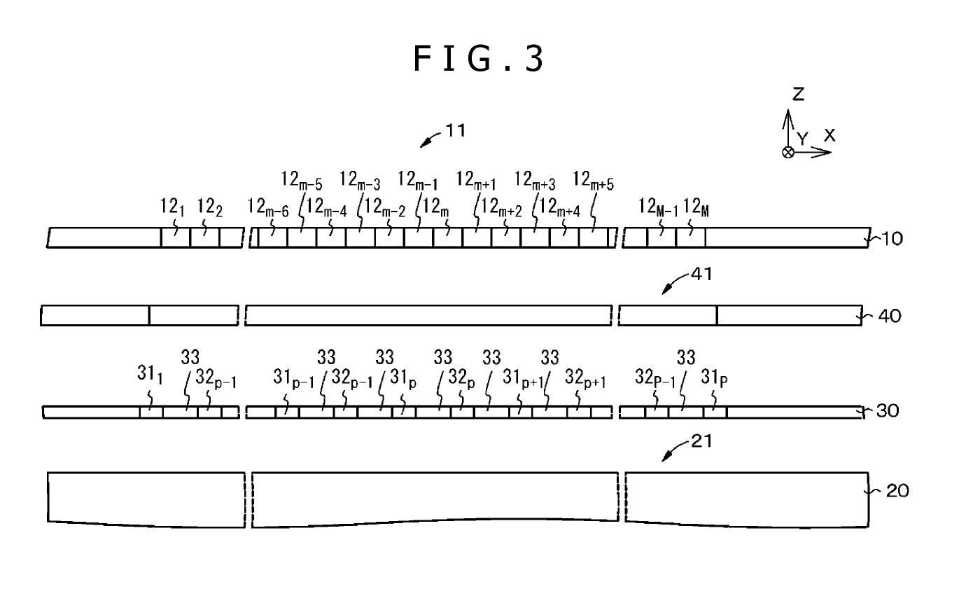

FIG. 1 is a conceptual view of an image display apparatus 1 according to Embodiment 1 of the present disclosure. FIG. 2 is a schematic exploded perspective view of the image display apparatus 1 according to Embodiment 1. FIG. 3 is a fragmentary schematic end view of the image display apparatus 1 according to Embodiment 1, showing the layout of a transmissive display panel, a light regulator, an optical separator, and an illuminator of the image display apparatus 1.

As shown in FIGS. 1 and 2, the image display apparatus 1 includes a transmissive display panel 10, an illuminator 20 for illuminating a rear surface of the transmissive display panel 10, an optical separator 30, which includes a plurality of switchers capable of switching between a light transmitting state and a light blocking state, for separating an image displayed on the transmissive display panel 10 into a plurality of viewpoint images by bringing one of the switchers into the light transmitting state and the other switchers into the light blocking state, and a light regulator 40 capable of switching between a light diffusing state and a light transmitting state. The transmissive display panel 10, the optical separator 30, and the light regulator 40 are driven by a driver 100.

The optical separator 30 is disposed between the transmissive display panel 10 and the illuminator 20. The light regulator 40 is disposed between the optical separator 30 and the transmissive display panel 10. As described later, when a plurality of viewpoint images are displayed on the transmissive display panel 10, the light regulator 40 is brought into the light transmitting state by the driver 100, and when a single viewpoint image is displayed on the transmissive display panel 10, the light regulator 40 is brought into the light diffusing state by the driver 100.

The transmissive display panel 10 includes a display area 11 having a matrix of pixels 12 which are arranged in an array of M columns spaced in a horizontal direction, i.e., in the direction indicated by the arrow X and an array of N rows spaced in a vertical direction, i.e., in the direction indicated by the arrow Y. Those pixels 12 which belong to the mth column (m=1, 2, . . . , M) will be referred to as pixels 12ₘ.

The transmissive display panel 10 is an active matrix color liquid crystal display panel. Each of the pixels 12 is made of a combination of a red light-emitting auxiliary pixel, a green light-emitting auxiliary pixel, and a blue light-emitting auxiliary pixel.

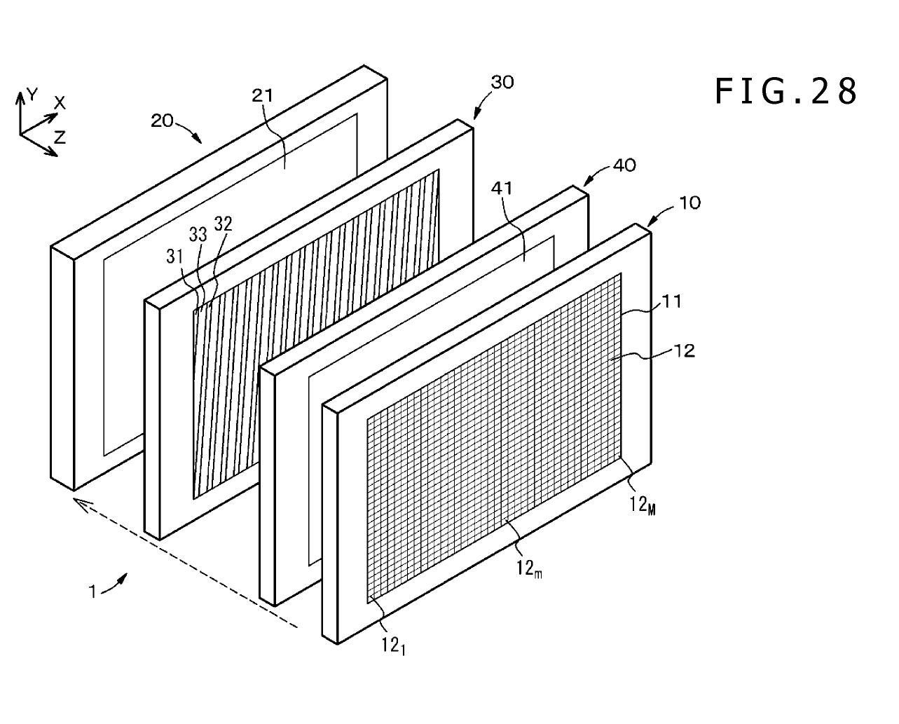

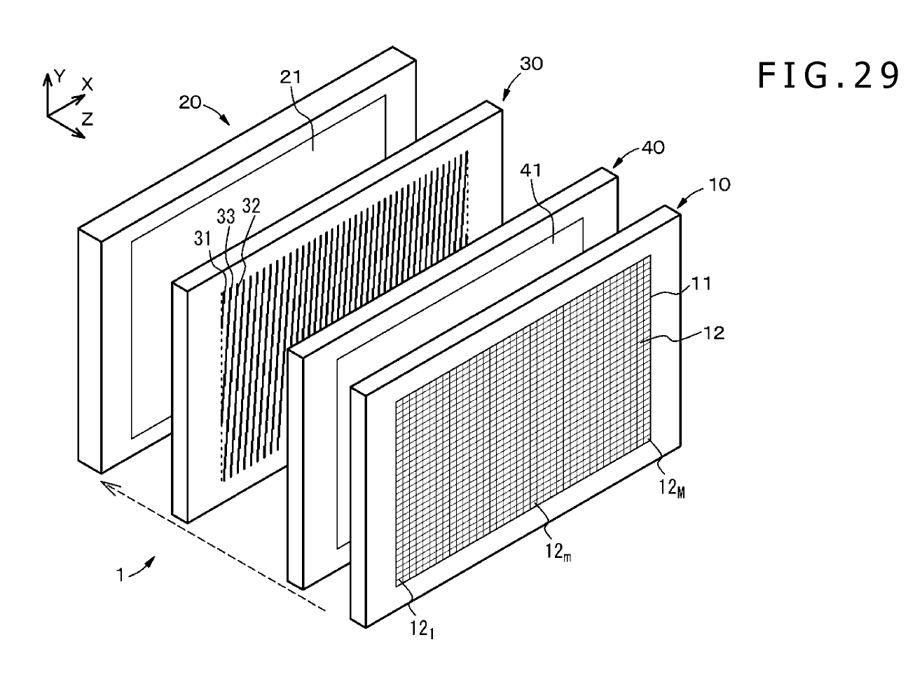

The transmissive display panel 10 has a front panel on the side of observational areas, a rear panel on the side of the optical separator 30, and a liquid crystal material layer interposed between the front panel and the rear panel. For illustrative purposes, the transmissive display panel 10 is shown as a single panel. The transmissive display panel 10 is also shown as a single panel in FIGS. 28 and 29 to be described later.

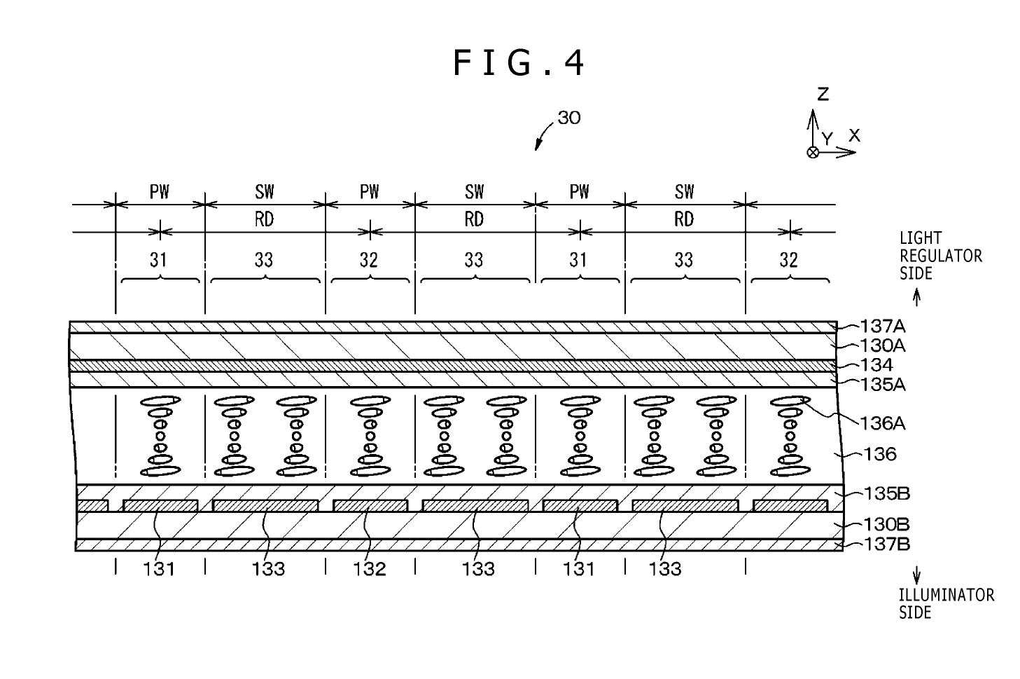

Polarizer films, not shown, are disposed respectively on the surface of the transmissive display panel 10 which faces the observational areas and the surface of the transmissive display panel 10 which faces the light regulator 40. Usually, the polarizer films are oriented with respect to each other such that their polarizing axes extend perpendicularly to each other, i.e., they are in a cross Nicol state, or parallel to each other, i.e., they are in a parallel Nicol state, depending on the specifications of the transmissive display panel 10. In order to allow light that has passed through the optical separator 30 to travel smoothly to the transmissive display panel 10, the polarizing axis of the polarizer film that is disposed on the surface of the transmissive display panel 10 which faces the light regulator 40 is in alignment with the polarizing axis of a polarizer film 137A, to be described later, shown in FIG. 4.

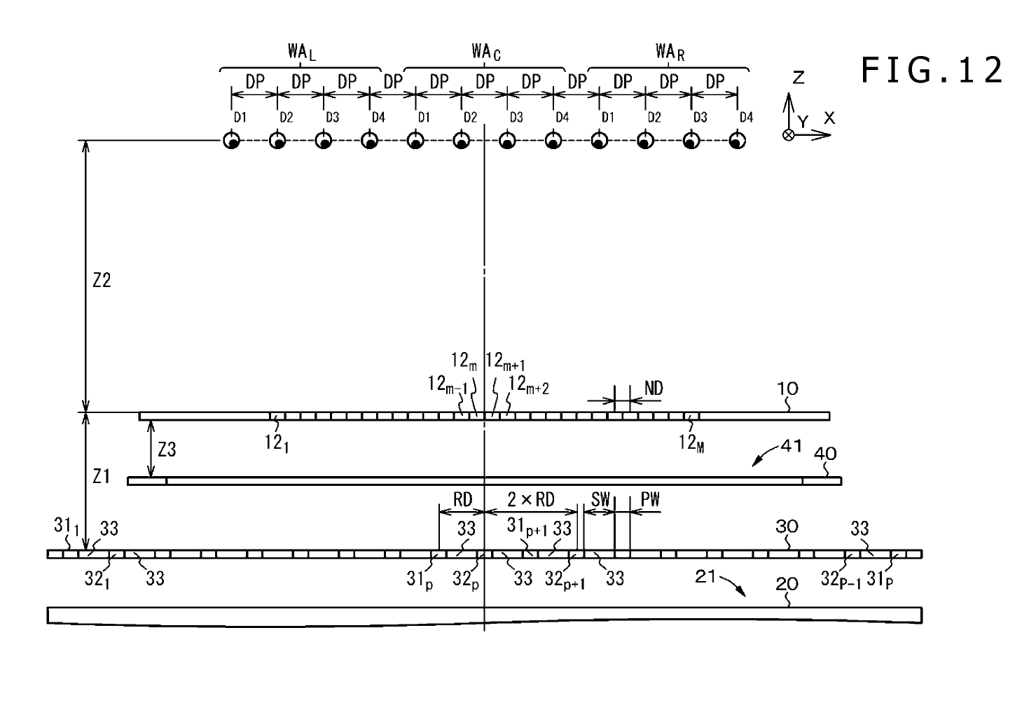

As shown in FIGS. 2 and 3, the switchers of the optical separator 30 include a plurality of first switchers 31, second switchers 32, and third switchers 33 which extend substantially vertically in the direction indicated by the arrow Y in FIGS. 2 and 3 and which are juxtaposed horizontally in the direction indicated by the arrow X. The first switchers 31 and the second switchers 32 are alternately disposed horizontally with the third switchers 33 interposed therebetween. The first switchers 31, the second switchers 32, and the third switchers 33 thus juxtaposed horizontally jointly make up a barrier forming area. According to Embodiment 1, the optical separator 30 includes P first switchers 31 and (P−1) second switchers 32. The number of the third switchers 33 is the same as the number of the second switchers 32. The pth (p=1, 2, . . . , P) first switcher 31 is denoted by 31ₚ. The pth (p=1, 2, . . . , P) second switcher 32 is denoted by 32ₚ. The first switchers 31, the second switchers 32, and the third switchers 33 may hereinafter collectively be referred to as switchers 31, 32, 33. The relationship between “P” and “M” will be described later with reference to FIGS. 12, 13, and 14.

In Embodiment 1, each of three observational areas WA_{L}, WA_{C}, WA_{R} shown in FIG. 1 has four viewpoints D1, D2, D3, D4 for images used to display a stereoscopic image. However, the number of observational areas and the number of viewpoints in each of the observational areas are not limited to those illustrated, but may be selected depending on design details of the image display apparatus 1.

The illuminator 20 includes a light source, a prism sheet, a diffusion sheet, and a light guide plate (not shown). The illuminator 20 has a light-emitting surface 21 for emitting diffused light. The diffused light emitted from the light-emitting surface 21 travels through the optical separator 30 and the light regulator 40 toward the rear surface of the transmissive display panel 10. When the optical separator 30 blocks part of the light from the illuminator 20, the image displayed on the transmissive display panel 10 is divided into a plurality of viewpoint images.

The optical separator 30 will be described below with reference to FIGS. 4 through 9.

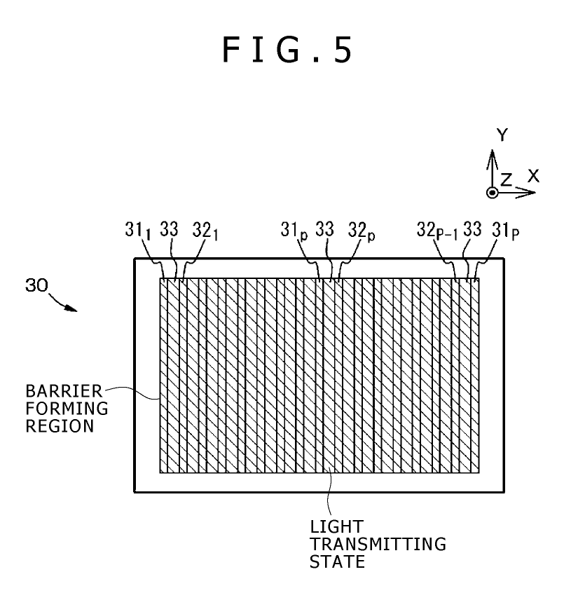

FIG. 4 is a fragmentary schematic cross-sectional view of the optical separator 30 at the time the first switchers 31, the second switchers 32, and the third switchers 33 are in the light transmitting state. FIG. 5 is a schematic front elevational view of the optical separator 30 at the time the first switchers 31, the second switchers 32, and the third switchers 33 are in the light transmitting state.

In FIG. 4, the reference character PW represents the width of each of the first switchers 31 and the second switchers 32 in the horizontal direction, i.e., the direction indicated by the arrow X, the reference character SW represents the width of each of the third switchers 33 in the horizontal direction, and the reference character RD represents the horizontal pitch between the first switchers 31 and the second switchers 32. Since the first switchers 31 and the second switchers 32 are alternately disposed horizontally with the third switchers 33 interposed therebetween, both the horizontal pitch between a first switcher 31 and an adjacent first switcher 31, and the horizontal pitch between a second switcher 32 and an adjacent second switcher 32 are represented by 2×RD.

The optical separator 30 has a pair of light transmissive substrates 130A, 130B each in the form of a glass substrate and a liquid crystal material layer 136 disposed between the light transmissive substrates 130A, 130B. The optical separator 30 includes a plurality of switchers 31, 32, 33 which are capable of switching between the light transmitting state and the light blocking state. An image displayed on the transmissive display panel 10 is separated into a plurality of viewpoint images by bringing one of the switchers into the light transmitting state and the other switchers into the light blocking state.

More specifically, a transparent common electrode 134 which is made of ITO, for example, is disposed on the entire surface of the light transmissive substrate 130A on the side of the liquid crystal material layer 136, and an orientation film 135A which is made of polyimide, for example, is disposed on the transparent common electrode 134. First transparent electrodes 131, second transparent electrodes 132, and third transparent electrodes 133 which are made of ITO, for example, and aligned with the switchers 31, 32, 33, respectively, are disposed on the light transmissive substrate 130B on the side of the liquid crystal material layer 136. The first transparent electrodes 131, second transparent electrodes 132, and third transparent electrodes 133 may hereinafter collectively be referred to as transparent electrodes 131, 132, 133.

The transparent electrodes 131, 132, 133 are of a substantially striped planar shape. An orientation film 135B which is made of polyimide, for example, is disposed on the light transmissive substrate 130B including the transparent electrodes 131, 132, 133. The transparent common electrode 134 and the transparent electrodes 131, 132, 133 may be switched around in position.

The surface of the orientation film 135A on the side of the liquid crystal material layer 136 is oriented by a known process such as a rubbing process, for example, in a direction which is inclined at 135 degrees to an X-axis in an X-Y plane where X and Y represent the directions indicated by the arrows X, Y. The surface of the orientation film 135B on the side of the liquid crystal material layer 136 is similarly oriented in a direction which is inclined at 45 degrees to the X-axis in the X-Y plane.

FIG. 4 shows a state of the optical separator 30 wherein no electric field is generated between the transparent common electrode 134 and the transparent electrodes 131, 132, 133. In this state, liquid crystal molecules 136A of the liquid crystal material layer 136 have molecule axes (called “director”) whose directions are inclined at 135 degrees to the X-axis in the X-Y plane on the side of the light transmissive substrate 130A. The directions of the molecular axes are gradually changed along a direction toward the light transmissive substrate 130B, and are inclined at 45 degrees to the X-axis in the X-Y plane on the side of the light transmissive substrate 130B. The liquid crystal material layer 136 operates in a so-called TN (Twisted Nematic) mode.

A polarizer film 137A is disposed on the surface of the light transmissive substrate 130A on the side of the light regulator 40, and a polarizer film 137B is disposed on the surface of the light transmissive substrate 130B on the side of the illuminator 20. The polarizer film 137A is oriented such that its polarizing axis is inclined 135 degrees to the X-axis in the X-Y plane. The polarizer film 137B is oriented such that its polarizing axis is inclined 45 degrees to the X-axis in the X-Y plane. The polarizer films 137A, 137B are oriented with respect to each other such that their polarizing axes extend perpendicularly to each other, i.e., they are in the cross Nicol state.

The first transparent electrodes 131 are electrically connected to each other by interconnects, not shown. Similarly, the second transparent electrodes 132 are electrically connected to each other by interconnects, not shown, and the third transparent electrodes 133 are electrically connected to each other by interconnects, not shown.

A constant voltage of 0 volts, for example, is applied to the transparent common electrode 134 by the driver 100, and independent voltages are applied respectively to the first transparent electrodes 131, the second transparent electrodes 132, and the third transparent electrodes 133 by the driver 100.

Operation of the optical separator 30 at the time no electric field is generated between the transparent common electrode 134 and the transparent electrodes 131, 132, 133, or stated otherwise, voltages of the same value are applied to the transparent common electrode 134 and the transparent electrodes 131, 132, 133, will be described below. Light that is applied through the polarizer film 137B to the liquid crystal material layer 136 has its direction of polarization changed 90 degrees by the liquid crystal molecules 136A, and passes through the polarizer film 137A. Therefore, the optical separator 30 operates in a so-called normally white mode.

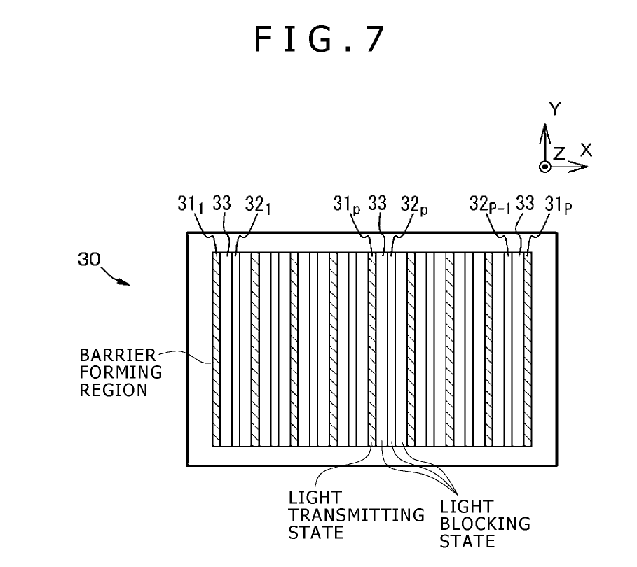

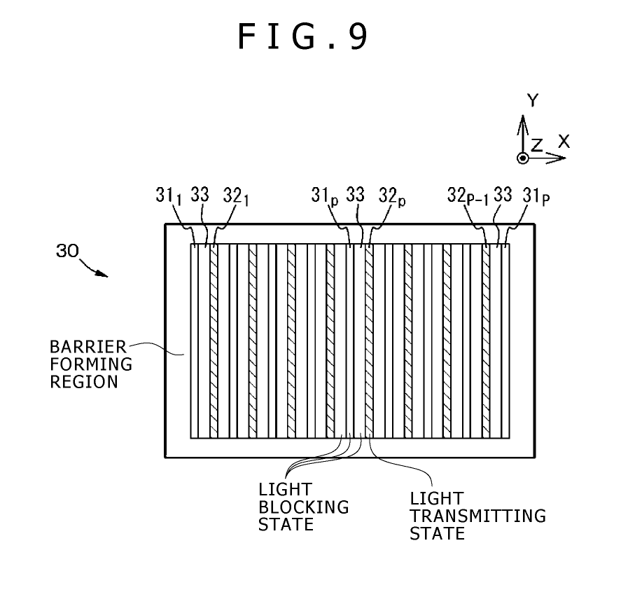

When no electric field is generated between the transparent common electrode 134 and the transparent electrodes 131, 132, 133, as shown in FIG. 5, the barrier forming area made up by the switchers 31, 32, 33 is wholly in the light transmitting state. In FIG. 5, and also in FIGS. 7 and 9 to be described later, any area which is in the light transmitting state is shown hatched.

In order to bring the first switchers 31 into the light transmitting state and the second switchers 32 and the third switchers 33 into the light blocking state, therefore, a voltage which is of the same value as the voltage applied to the transparent common electrode 134, i.e., a voltage of 0 volts, may be applied to the first transparent electrodes 131, and a voltage other than the voltage of 0 volts may be applied to the second transparent electrodes 132 and the third transparent electrodes 133. At this time, a voltage of the same value may be applied to the second transparent electrodes 132 and the third transparent electrodes 133, or voltages of different values may be applied to the second transparent electrodes 132 and the third transparent electrodes 133.

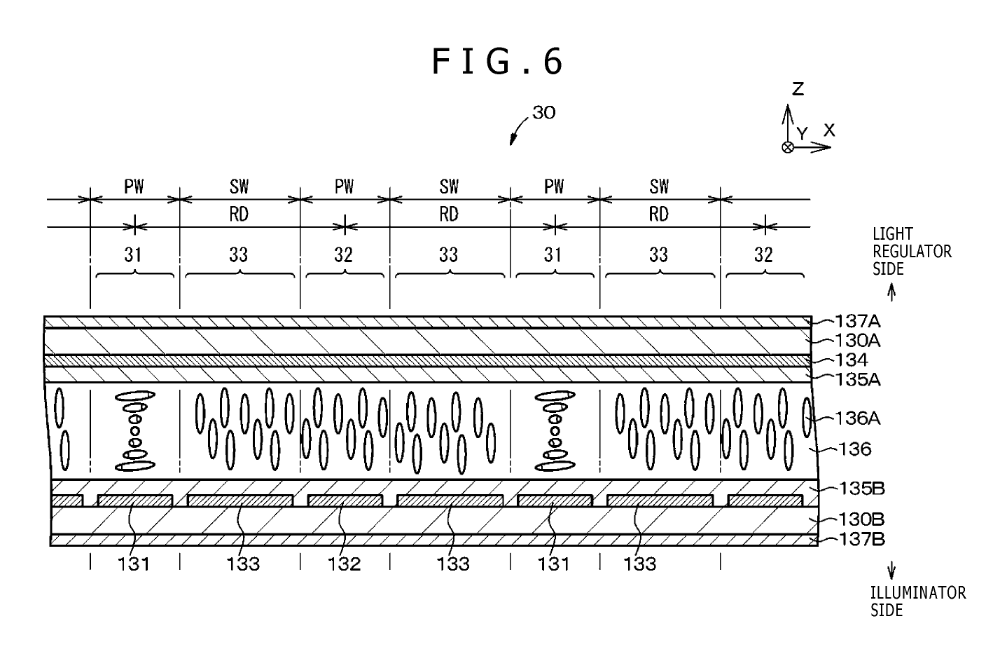

FIG. 6 is a fragmentary schematic cross-sectional view of the optical separator 30 at the time the first switchers 31 are in the light transmitting state and the second switchers 32 and the third switchers 33 are in the light blocking state. FIG. 7 is a schematic front elevational view of the optical separator at the time the first switchers 31 are in the light transmitting state and the second switchers 32 and the third switchers 33 are in the light blocking state.

As shown in FIG. 6, when a given voltage is applied to the second transparent electrodes 132 and the third transparent electrodes 133, the liquid crystal molecules 136A that are positioned between the transparent common electrode 134 and the second transparent electrodes 132 and the liquid crystal molecules 136A that are positioned between the transparent common electrode 134 and the third transparent electrodes 133 are basically oriented in the direction indicated by the arrow Z in FIG. 6. In the areas where the liquid crystal molecules 136A are oriented in the direction indicated by the arrow Z, the light that is applied through the polarizer film 137B to the liquid crystal material layer 136 reaches the polarizer film 137A with its direction of polarization remaining unchanged. Since the polarizer film 137A and the polarizer film 137B are in the cross Nicol state, the second switchers 32 and the third switchers 33 are in the light blocking state, as shown in FIG. 7. The first switchers 31 are in the light transmitting state, as is the case with the first switchers 31 shown in FIG. 4.

In order to bring the second switchers 32 into the light transmitting state and the first switchers 31 and the third switchers 33 into the light blocking state, therefore, a voltage which is of the same value as the voltage applied to the transparent common electrode 134, i.e., a voltage of 0 volts, may be applied to the second transparent electrodes 132, and a voltage other than the voltage of 0 volts may be applied to the first transparent electrodes 131 and the third transparent electrodes 133. At this time, a voltage of the same value may be applied to the first transparent electrodes 131 and the third transparent electrodes 133, or voltages of different values may be applied to the first transparent electrodes 131 and the third transparent electrodes 133.

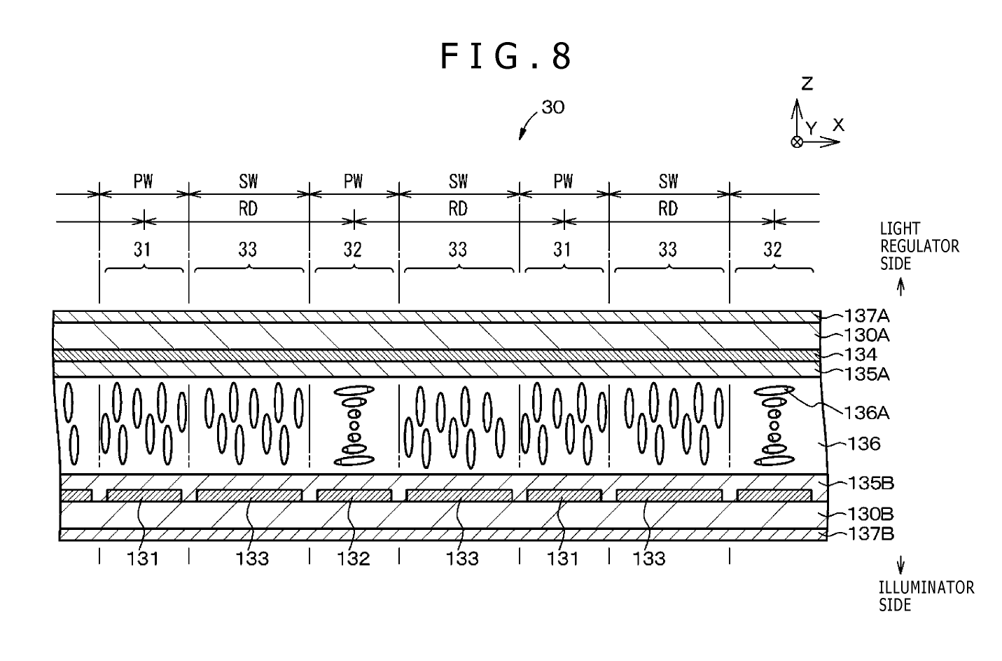

FIG. 8 is a fragmentary schematic cross-sectional view of the optical separator 30 at the time the second switchers 32 are in the light transmitting state and the first switchers 31 and the third switchers 33 are in the light blocking state. FIG. 9 is a schematic front elevational view of the optical separator 30 at the time the second switchers 32 are in the light transmitting state and the first switchers 31 and the third switchers 33 are in the light blocking state. Specific details of the operation of the optical separator 30 in FIGS. 8 and 9 are similar to those of the operation of the optical separator 30 in FIGS. 6 and 7 except that the second switchers 32, rather than the first switchers 31, are in the light transmitting state, and the first switchers 31 and the third switchers 33, rather than the second switchers 32 and the third switchers 33 are in the light blocking state, and hence will not be described below.

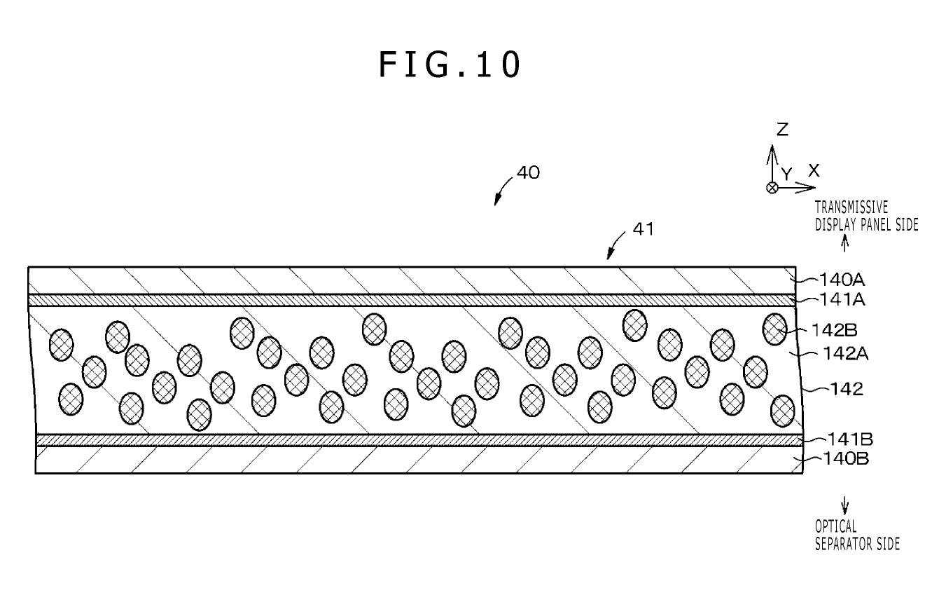

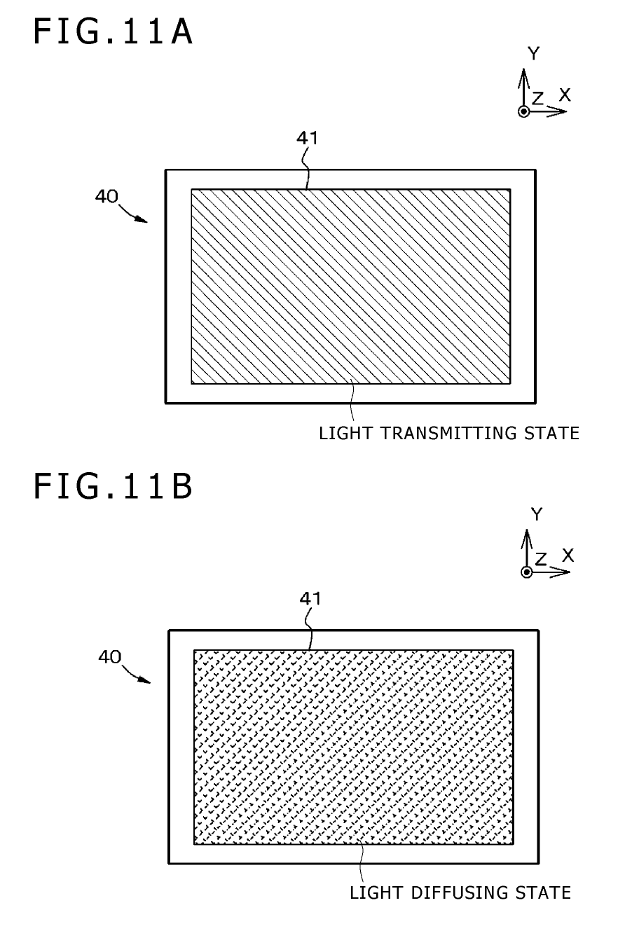

The light regulator 40 will be described below with reference to FIGS. 10, 11A, and 11B.

FIG. 10 is a fragmentary schematic cross-sectional view of the light regulator 40. FIG. 11A is a schematic front elevational view illustrative of the light regulator 40 whose light regulating surface 41 is in the light transmitting state. FIG. 11B is a schematic front elevational view illustrative of the light regulator 40 whose light regulating surface 41 is in the light diffusing state.

As shown in FIG. 10, the light regulator 40 includes a diffused liquid crystal material layer 142 which switches between a light transmitting state and a light diffusing state depending on a voltage applied thereto. The light regulator 40 also includes a pair of light transmissive support bodies 140A, 140B each having a transparent electrode and the diffused liquid crystal material layer 142 disposed therebetween.

Each of the light transmissive support bodies 140A, 140B is in the form of a film made of a light transmissive material such as polyethylene terephthalate (PET), for example. Transparent electrodes 141A, 141B made of ITO, for example, are disposed on the respective entire surfaces of the light transmissive support bodies 140A, 140B which face the diffused liquid crystal material layer 142. The diffused liquid crystal material layer 142 has a base medium 142A of polymeric material and a liquid crystal material 142B diffused in the base medium 142A.

A constant voltage of 0 volts, for example, is applied to one, for example, the transparent electrode 141A, of the transparent electrodes 141A, 141B by the driver 100, and a given voltage is applied to the other transparent electrode 141B by the driver 100.

The diffused liquid crystal material layer 142 is in the light transmitting state when an electric field is generated between the transparent electrodes 141A, 141B (see FIG. 11A), and in the light diffusing state when no electric field is generated between the transparent electrodes 141A, 141B (see FIG. 11B). In other words, in order to bring the light regulating surface 41 of the light regulator 40 into the light diffusing state, a voltage which is of the same value as the voltage applied to the transparent electrode 141A, i.e., a voltage of 0 volts, is applied to the transparent electrode 141B by the driver 100. In order to bring the light regulating surface 41 of the light regulator 40 into the light transmitting state, a voltage other than the voltage of 0 volts is applied to the transparent electrode 141B by the driver 100.

The layout of the viewpoints D1, D2, D3, D4 in the observational areas WA_{L}, WA_{C}, WA_{R}, the transmissive display panel 10, and the optical separator 30 shown in FIG. 1 will be described below.

FIG. 12 is a schematic plan view showing the layout of the viewpoints D1, D2, D3, D4 in the observational areas WA_{L}, WA_{C}, WA_{R}, the transmissive display panel 10, and the first switchers 31, the second switchers 32, and the third switchers 33 of the optical separator 30 shown in FIG. 1.

For illustrative purposes, it is assumed that the pth second switcher 32ₚ is positioned intermediate between the 1st first switcher 31₁ and the Pth first switcher 31ₚ and that the boundary between the mth column of pixels 12ₘ and the (m+1)th column of pixels 12ₘ₊₁ and the midpoint between the viewpoints D2, D3 in the observational area WA_{C} are positioned on a hypothetical straight line passing through the center of the pth second switcher 32ₚ and extending in the direction indicated by the arrow Z. The pixel pitch is represented by ND [mm]. The distance between the optical separator 30 and the transmissive display panel 10 is represented by Z1 [m]. The distance between the transmissive display panel 10 and the observational areas WA_{L}, WA_{C}, WA_{R} is represented by Z2 [m]. The distance between the transmissive display panel 10 and the light regulator 40 is represented by Z3 [m]. In the observational areas WA_{L}, WA_{C}, WA_{R}, the distance between any adjacent two of the viewpoints is represented by DP [mm].

As described above, the horizontal pitch in the direction indicated by the arrow X in FIG. 12 between the first switchers 31 and the second switchers 32 is represented by RD [mm]. The width of each of the third switchers 33 in the horizontal direction is represented by SW [mm], and the width of each of the first switchers 31 and the second switchers 32 in the horizontal direction is represented by PW [mm].

As shown in FIG. 12, the pitch RD is related to the widths SW, PW according to RD=SW+PW. Qualitatively, as the value of PW/RD=PW/(SW+PW) is smaller, the directivity of the image display apparatus 1 in displaying stereoscopic images is greater, though the luminance of the observed images is lower. The value of PW/RD should be set to a preferred value depending on the specifications of the image display apparatus 1.

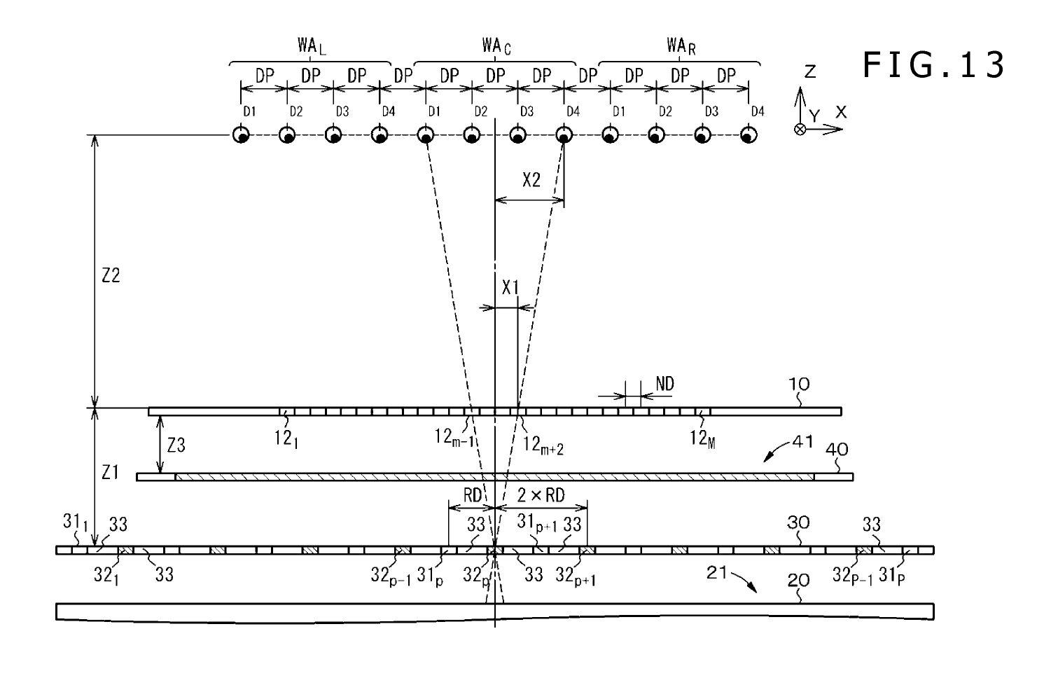

FIG. 13 is a schematic plan view illustrative of conditions to be met for light from a pixel 12 to travel to the viewpoints D1, D2, D3, D4 in the central observational area WA_{C}.

Conditions to be met for light from the second switcher 32ₚ that passes through the pixels 12ₘ₋₁, 12ₘ, 12ₘ₊₁, 12ₘ₊₂ to travel to the viewpoints D1, D2, D3, D4 in the central observational area WA_{C} will be considered below.

In FIG. 13, the second switchers 32 are in the light transmitting state, and the first switchers 31 and the third switchers 33 are in the light blocking state. The light regulating surface 41 of the light regulator 40 is in the light transmitting state. In FIG. 13 and other figures, the second switchers 32 and the light regulating surface 41 of the light regulator 40 which are in the light transmitting state are shown hatched in order to distinguish between the light transmitting state and the light blocking state.

For illustrative purposes, the width PW of the first switchers 31 and the second switchers 32 is sufficiently small, and the path of light that passes through the center of the pth second switcher 32ₚ will be described below.

The distance from the hypothetical straight line passing through the center of the pth second switcher 32ₚ and extending in the direction indicated by the arrow Z to the center of the pixel 12ₘ₊₂ is represented by X1, and the distance from the same hypothetical straight line to the viewpoint D4 in the central observational area WA_{C} is represented by X2. When light from the pth second switcher 32ₚ passes through the pixel 12ₘ₊₂ toward the viewpoint D4 in the central observational area WA_{C}, the following equation (1) is satisfied based on a geometrical similarity relationship:

Z1:X1=(Z1+Z2):X2 (1)

Since X1=1.5×ND, X2=1.5×DP, the equation (1) is modified into the following equation (1′):

Z1:1.5×ND=(Z1+Z2):1.5×DP (1′)

It is geometrically apparent that if the equation (1′) is satisfied, then light from the pth second switcher 32ₚ that passes through the pixels 12ₘ₋₁, 12ₘ, 12ₘ₊₁ also travels toward the viewpoints D1, D2, D3, respectively, in the central observational area WA_{C}.

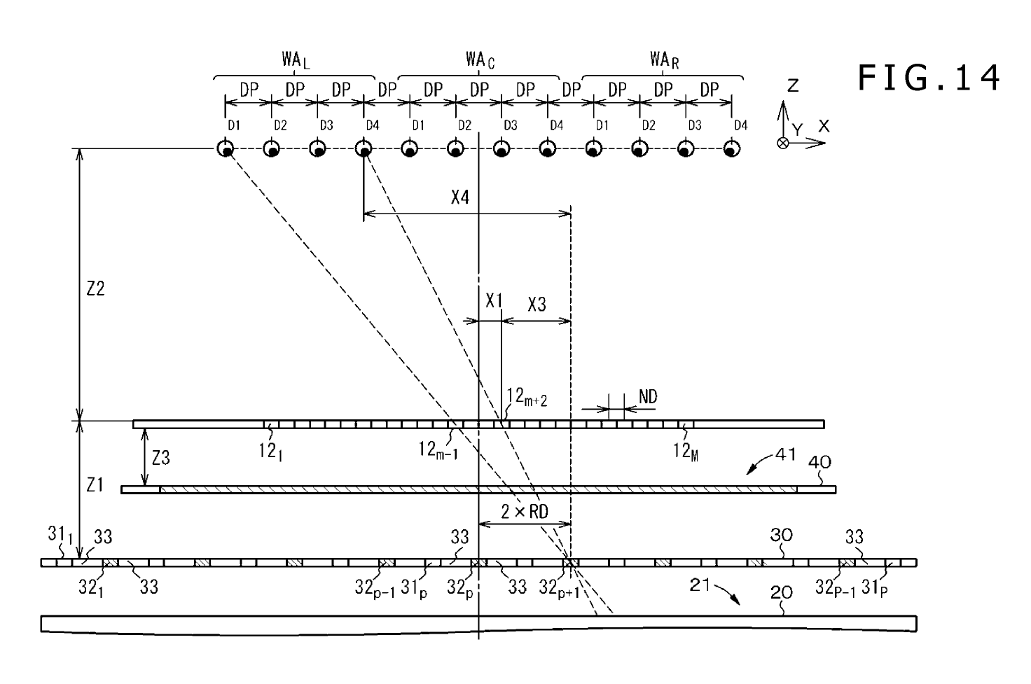

FIG. 14 is a schematic plan view illustrative of conditions to be met for light from a pixel 12 to travel to the viewpoints D1, D2, D3, D4 in the left observational area WA_{L}.

Conditions to be met for light from the second switcher 32ₚ₊₁ that passes through the pixels 12ₘ₋₁, 12ₘ, 12ₘ₊₁,12ₘ₊₂ to travel to the viewpoints D1, D2, D3, D4 in the left observational area WA_{L} will be considered below.

The distance from the hypothetical straight line passing through the center of the (p+1)th second switcher 32ₚ₊₁ and extending in the direction indicated by the arrow Z to the center of the pixel 12ₘ₊₂ is represented by X3, and the distance from the same hypothetical straight line to the viewpoint D4 in the left observational area WA_{L} is represented by X4. For light from the (p+1)th second switcher 32ₚ₊₁ to pass through the pixel 12ₘ₊₂ toward the viewpoint D4 in the left observational area WA_{L}, the following equation (2) is to be satisfied based on a geometrical similarity relationship:

Z1:X3=(Z1+Z2):X4 (2)

Since X3=2×RD−X1=2×RD−1.5×ND, X4=2×RD+2.5×DP, the equation (2) is modified into the following equation (2′):

Z1:(2×RD−1.5×ND)=(Z1+Z2):(2×RD+2.5×DP) (2′)

It is geometrically apparent that if the equation (2′) is satisfied, then light from the (p+1)th second switcher 32ₚ₊₁ that passes through the pixels 12ₘ₋₁, 12ₘ, 12ₘ₊₁ also travels toward the viewpoints D1, D2, D3, respectively, in the left observational area WA_{L}.

Conditions to be met for light from the (p−1)th second switcher 32ₚ₋₁ that passes through the pixels 12ₘ₋₁, 12ₘ, 12ₘ₊₁, 12ₘ₊₂ to travel to the viewpoints D1, D2, D3, D4 in the right observational area WA_{R} can be determined from a diagram which is produced by reversing the diagram of FIG. 14 about the Z-axis that extends along the direction indicated by the arrow Z, and will not be described in detail below.

The distance Z2 and the distance DP are set to values depending on the specifications of the image display apparatus 1. The value of the pixel pitch ND is determined depending on the structure of the transmissive display panel 10. From the above equations (1′), (2′), the distance Z1 and the pitch RD are expressed by the following equations (3), (4):

Z1=Z2×ND/(DP−ND) (3)

RD=2×DP×ND/(DP−ND) (4)

If the transmissive display panel 10 has a pixel pitch ND of 0.300 [m], a distance Z2 of 600 [m], and a distance DP of 65.0 [m], then the distance Z1 is of about 2.78 [m] and the pitch RD is of about 0.603 [m]. The distance Z3 may be set to an appropriate value depending on design details of the image display apparatus 1 in view of the thickness of the light regulator 40 and the value of the distance Z1. However, the value of the distance Z3 should preferably be as large as possible so that any dust and imperfections on the light regulator 40 will not adversely affect displayed images.

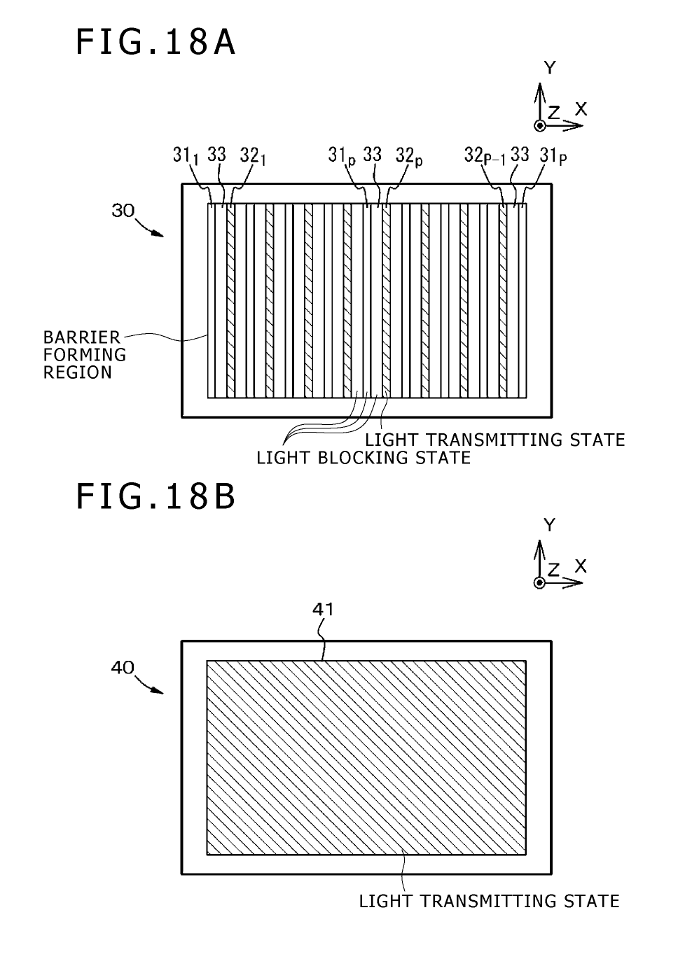

The distance Z1 and the pitch RD are set to values in order to satisfy the above conditions. The image observer can observe given viewpoint images at the viewpoints D1, D2, D3, D4 in the observational areas WA_{L}, WA_{C}, WA_{R}, as will be described in detail with reference to FIGS. 18A through 26B.

In the example given above, the value of the pitch RD between the first switchers 31 and the second switchers 32 is about twice the value of the pixel pitch ND. Therefore, the value of the pitch 2×RD between adjacent second switchers 32 is about four times the value of the pixel pitch ND. “M” and “P” referred to above are related to each other by M≈P×4.

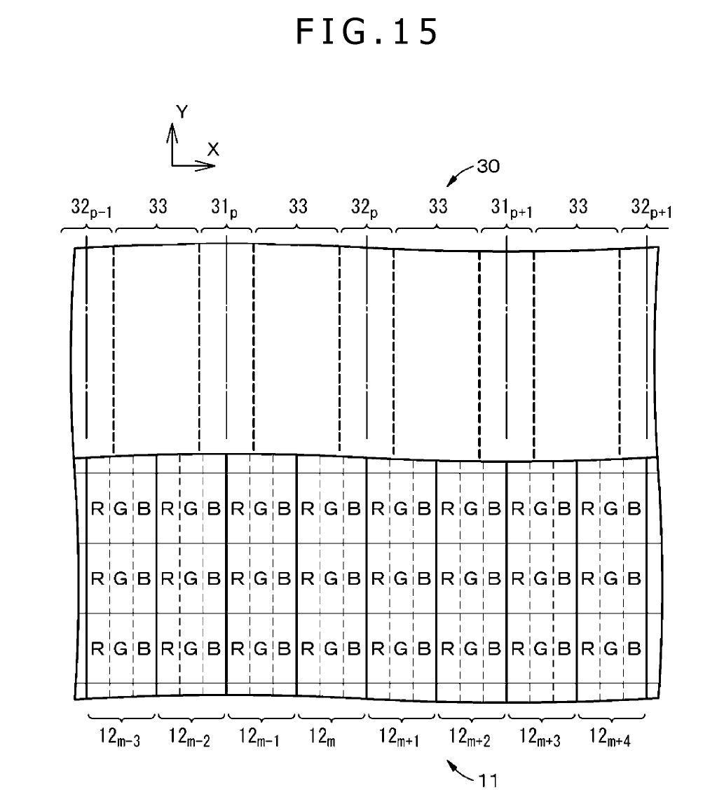

FIG. 15 is a fragmentary schematic plan view of the optical separator 30 and the display area 11, showing the layout of pixels 12, and the first switchers 31, the second switchers 32, and the third switchers 33 of the optical separator 30 of the image display apparatus 1 according to Embodiment 1.

In FIG. 15, the red light-emitting auxiliary pixel, the green light-emitting auxiliary pixel, and the blue light-emitting auxiliary pixel, which are arrayed horizontally, of each pixel 12 are represented by R, G, B, respectively. In FIG. 15, the light regulator 40 is omitted from illustration in order to clarify the layout of the pixels 12, and the first switchers 31, the second switchers 32, and the third switchers 33.

The image display apparatus 1 is capable of switching between the display of stereoscopic images and the display of ordinary images such as planar images based on the operation of the optical separator 30. First, a mode of operation of the image display apparatus 1 for displaying ordinary images such as planar images will be described below.

According to Embodiment 1, when a single viewpoint image is displayed on the transmissive display panel 10, the driver 100 operates to bring the light regulator 40 into the light diffusing state, and also operates to bring all the switchers of the optical separator 30 into the light transmitting state.

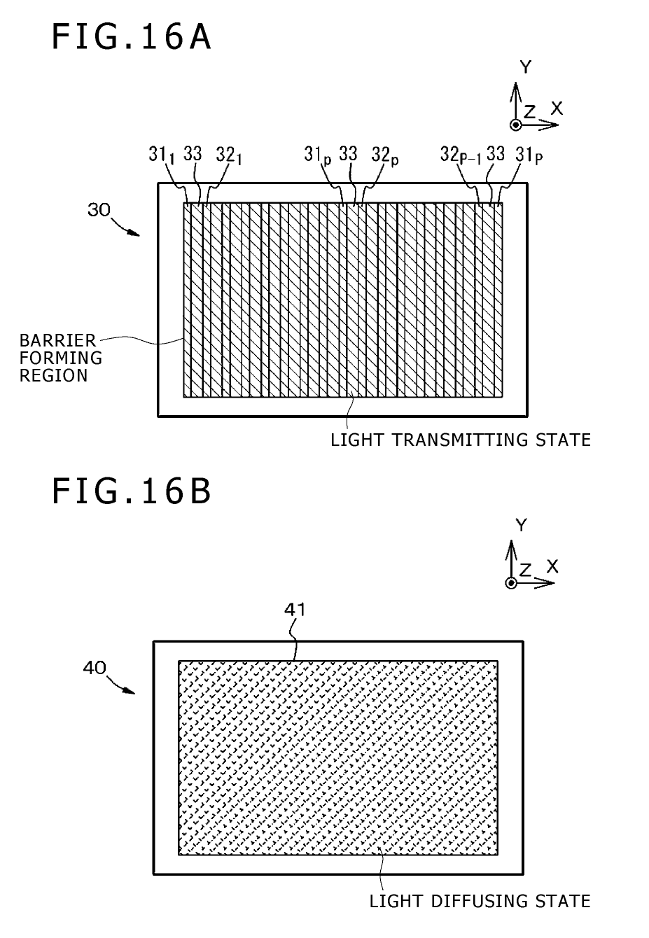

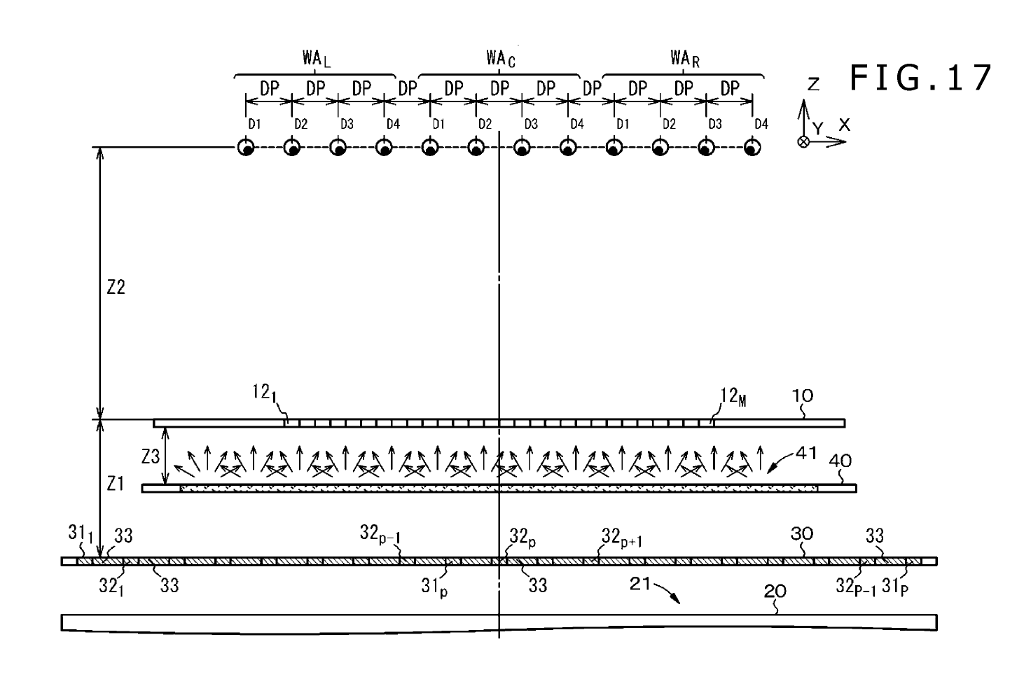

FIG. 16A is a schematic front elevational view illustrative of a state of the optical separator 30 for displaying an ordinary image. FIG. 16B is a schematic front elevational view illustrative of a state of the light regulator 40 for displaying an ordinary image. FIG. 17 is a schematic plan view illustrative of a state for displaying an ordinary image.

At this time, the optical separator 30 is in the normally white mode. The colors and luminance of the light that passes through the optical separator 30 change depending on the relationship between the oriented direction of the liquid crystal molecules of the optical separator 30 and the viewpoint of the image observer.

Since the light regulating surface 41 of the light regulator 40 is in the light diffusing state, the light from the optical separator 30 is turned into diffused light, which illuminates the back surface of the transmissive display panel 10. Therefore, the changes in the colors and luminance of the light referred above are reduced, resulting in a reduction in color irregularities and luminance irregularities in the displayed ordinary image.

Inasmuch as all the switchers, i.e., the first switchers 31, the second switchers 32, and the third switchers 33, of the optical separator 30 have been brought into the light transmitting state by the driver 100, the amount of light that passes through the optical separator 30 is maximum, enabling the transmissive display panel 10 to display an ordinary image of high luminance.

A mode of operation of the image display apparatus 1 for displaying stereoscopic images will be described below with reference to FIGS. 18A through 26B.

According to Embodiment 1, when a plurality of viewpoint images are displayed on the transmissive display panel 10, the driver 100 operates to switch alternately between a state in which the first switchers 31 are in the light transmitting state and the second switchers 32 and the third switchers 33 are in the light blocking state, and a state in which the second switchers 32 are in the light transmitting state and the first switchers 31 and the third switchers 33 are in the light blocking state, and also to synchronously switch between images displayed on the transmissive display panel 10. When a plurality of viewpoint images are displayed on the transmissive display panel 10, the driver 100 operates to bring the light regulator 40 into the light transmitting state.

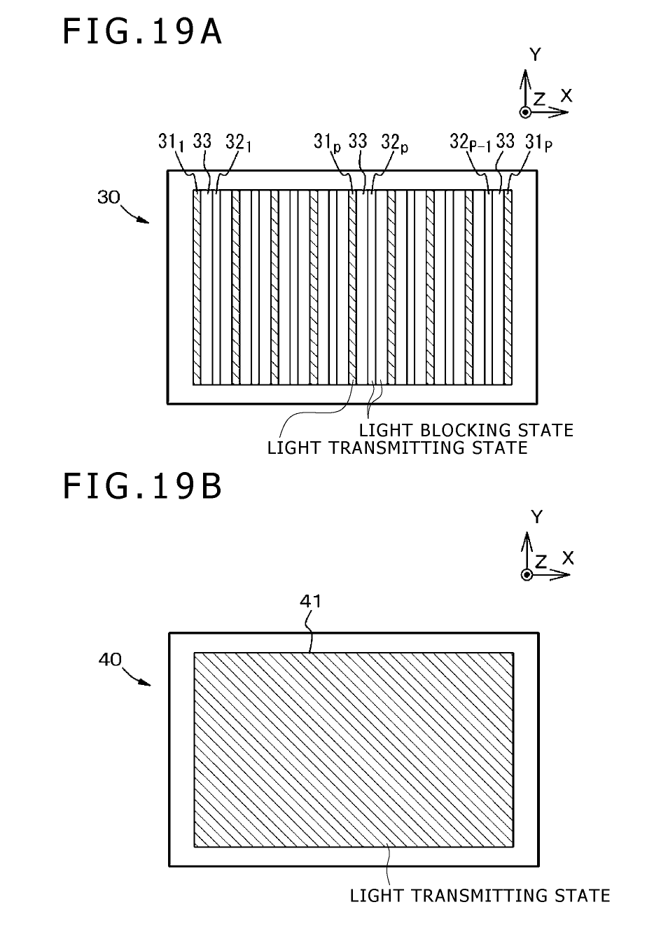

Specifically, when a plurality of viewpoint images are displayed on the transmissive display panel 10, the driver 100 operates to alternately switch between the state shown in FIGS. 18A and 18B and the state shown in FIGS. 19A and 19B, and also to synchronously switch between the images displayed on the transmissive display panel 10.

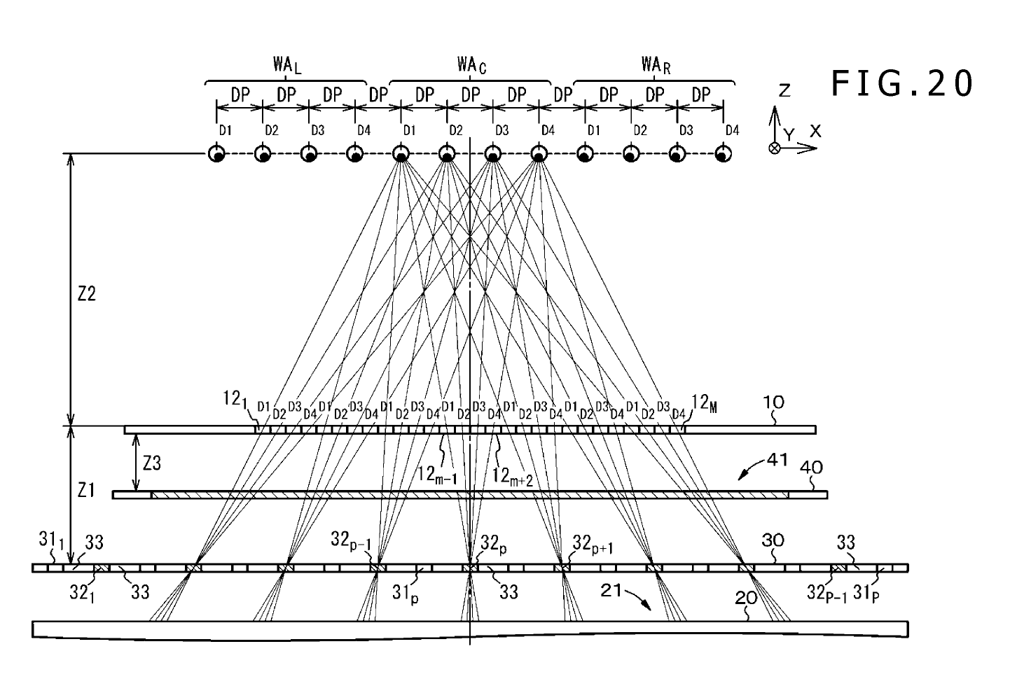

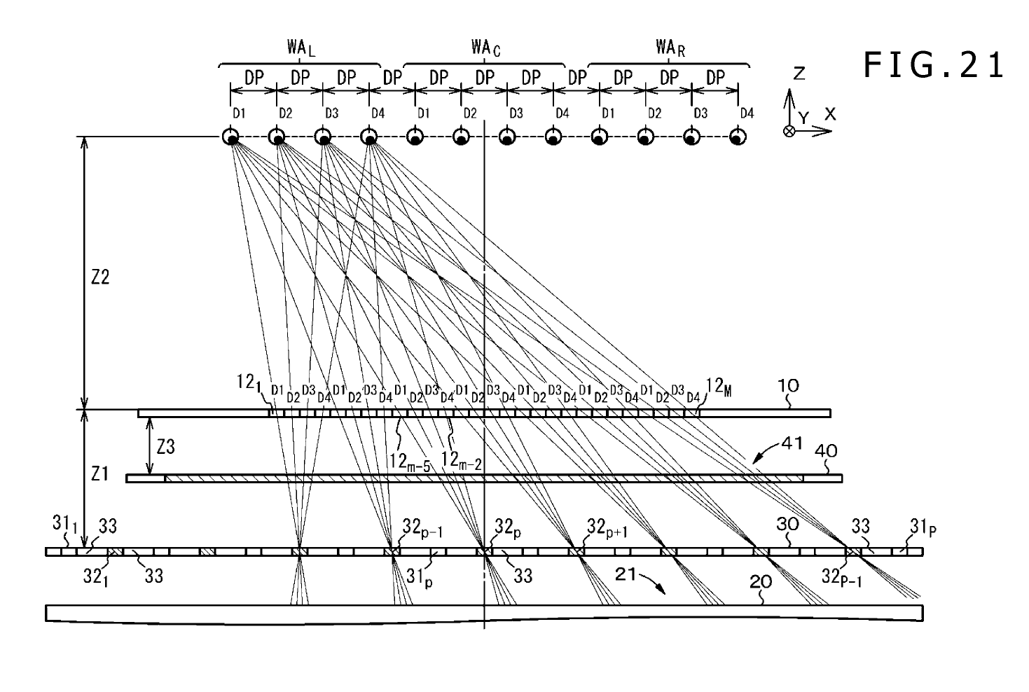

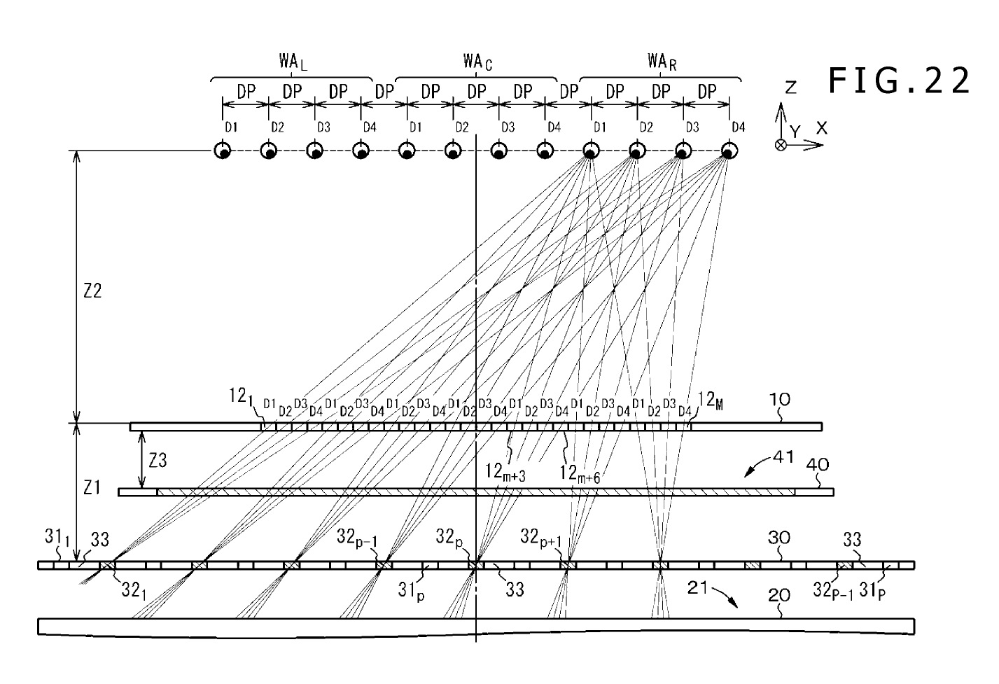

FIG. 20 is a schematic plan view illustrative of images that are observed at the viewpoints D1, D2, D3, D4 in the central observational area WA_{C} at the time the second switchers 32 are in the light transmitting state and the first switchers 31 and the third switchers 33 are in the light blocking state. FIG. 21 is a schematic plan view illustrative of images that are observed at the viewpoints D1, D2, D3, D4 in the left observational area WA_{L} at the time the second switchers 32 are in the light transmitting state and the first switchers 31 and the third switchers 33 are in the light blocking state. FIG. 22 is a schematic plan view illustrative of images that are observed at the viewpoints D1, D2, D3, D4 in the right observational area WA_{R} at the time the second switchers 32 are in the light transmitting state and the first switchers 31 and the third switchers 33 are in the light blocking state.

For example, light that passes through the pth second switcher 32ₚ will be described below. As shown in FIG. 20, the light passes through the (m−1)th through (m+2)th pixels 12 and is then observed at the viewpoints D1, D2, D3, D4 in the central observational area WA_{C}. As shown in FIG. 21, the light passes through the (m−5)th through (m−2)th pixels 12 and is then observed at the viewpoints D1, D2, D3, D4 in the left observational area WA_{L}. As shown in FIG. 22, the light passes through the (m+3)th through (m+6)th pixels 12 and is then observed at the viewpoints D1, D2, D3, D4 in the right observational area WA_{R}.

Light that passes through the (p+1)th second switcher 32ₚ₊₁ will be described below. As shown in FIG. 20, the light that travels toward the viewpoint D1 in the central observational area WA_{C} passes through the (m+3)th column of pixels 12ₘ₊₃, and the light that travels toward the viewpoint D2 in the central observational area WA_{C} passes through the (m+4)th column of pixels 12ₘ₊₄. The light that travels toward the viewpoint D3 in the central observational area WA_{C} passes through the (m+5)th column of pixels 12ₘ₊₅, and the light that travels toward the viewpoint D4 in the central observational area WA_{C} passes through the (m+6)th column of pixels 12ₘ₊₆. Light that passes through the (p−1)th second switcher 32ₚ₋₁ will not be described below as it can readily be understood from the above description of the light that passes through the (p+1)th second switcher 32ₚ₊₁ by reading the involved pixels as different pixels.

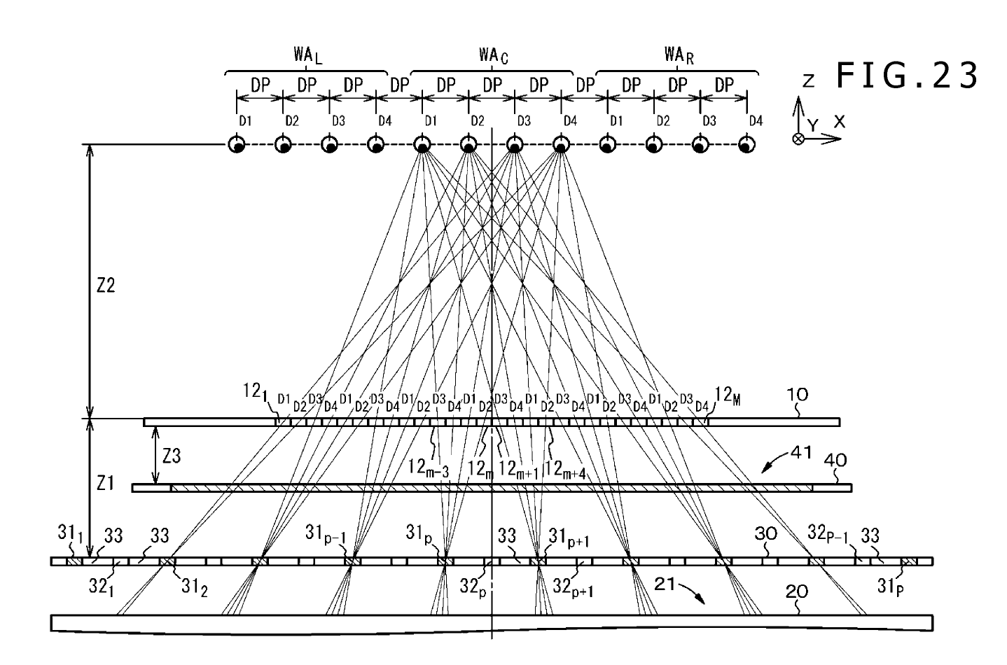

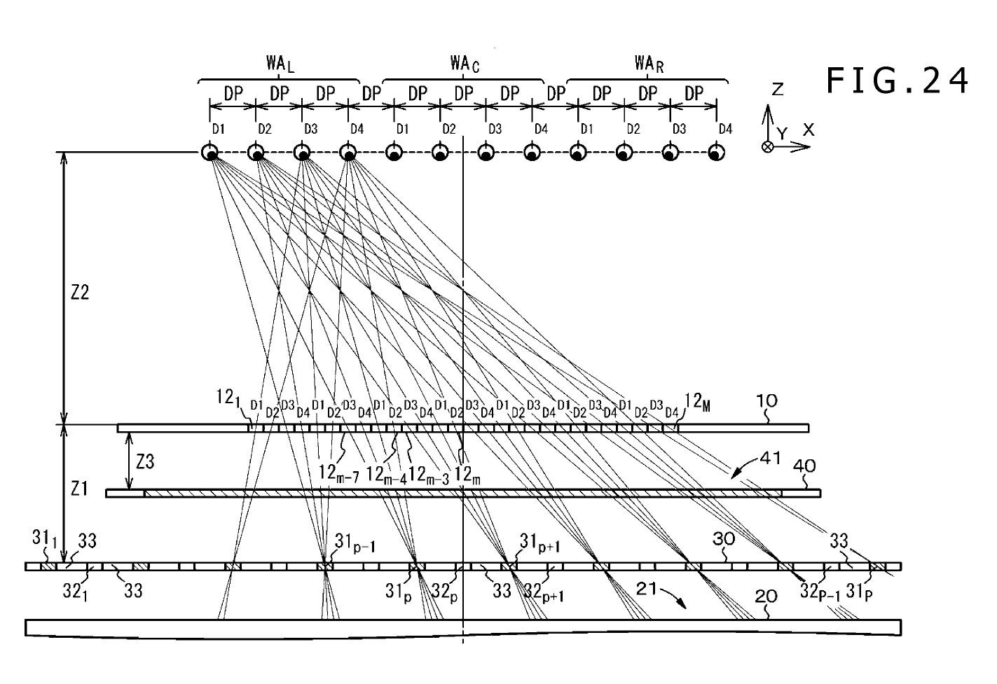

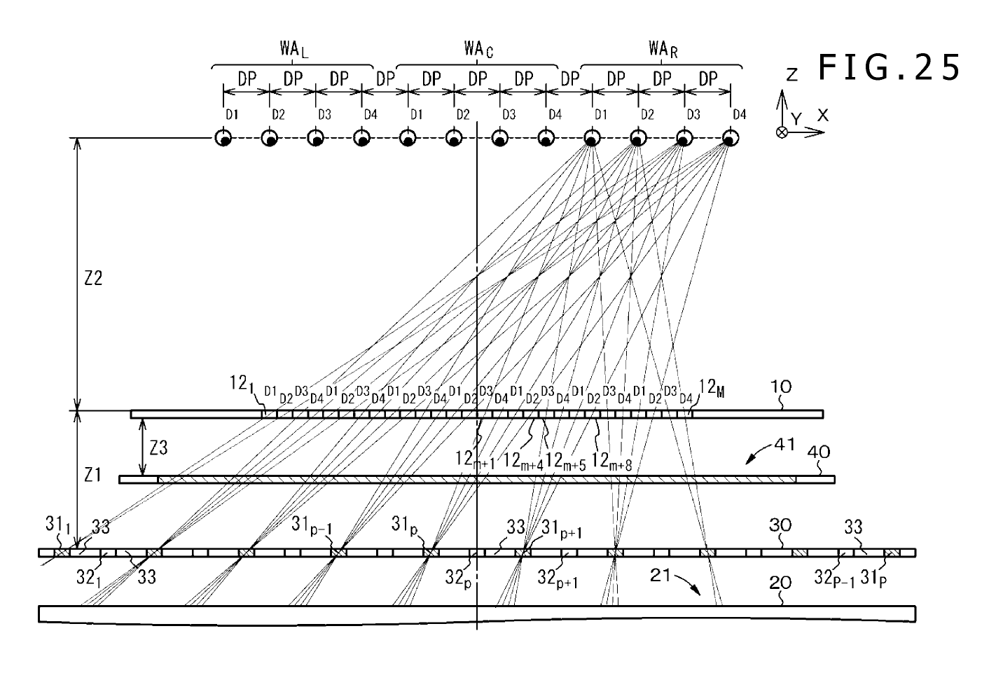

FIG. 23 is a schematic plan view illustrative of images that are observed at the viewpoints D1, D2, D3, D4 in the central observational area WA_{C} at the time the first switchers 31 are in the light transmitting state and the second switchers 32 and the third switchers 33 are in the light blocking state. FIG. 24 is a schematic plan view illustrative of images that are observed at the viewpoints D1, D2, D3, D4 in the left observational area WA_{L} at the time the first switchers 31 are in the light transmitting state and the second switchers 32 and the third switchers 33 are in the light blocking state. FIG. 25 is a schematic plan view illustrative of images that are observed at the viewpoints D1, D2, D3, D4 in the right observational area WA_{R} at the time the first switchers 31 are in the light transmitting state and the second switchers 32 and the third switchers 33 are in the light blocking state.

For example, light that passes through the pth first switcher 31ₚ will be described below. As shown in FIG. 23, the light passes through the (m−3)th through mth pixels 12 and is then observed at the viewpoints D1, D2, D3, D4 in the central observational area WA_{C}. As shown in FIG. 24, the light passes through the (m−7)th through (m−4)th pixels 12 and is then observed at the viewpoints D1, D2, D3, D4 in the left observational area WA_{L}. As shown in FIG. 25, the light passes through the (m+1)th through (m+4)th pixels 12 and is then observed at the viewpoints D1, D2, D3, D4 in the right observational area WA_{R}.

Light that passes through the (p+1)th first switcher 31ₚ₊₁ will be described below. As shown in FIG. 23, the light that travels toward the viewpoint D1 in the central observational area WA_{C} passes through the (m+1)th column of pixels 12ₘ₊₁, and the light that travels toward the viewpoint D2 in the central observational area WA_{C} passes through the (m+2)th column of pixels 12ₘ₊₂. The light that travels toward the viewpoint D3 in the central observational area WA_{C} passes through the (m+3)th column of pixels 12ₘ₊₃, and the light that travels toward the viewpoint D4 in the central observational area WA_{C} passes through the (m+4)th column of pixels 12ₘ₊₄. Light that passes through the (p−1)th first switcher 31ₚ₋₁ will not be described below as it can readily be understood from the above description of the light that passes through the (p+1)th first switcher 31ₚ₊₁ by reading the involved pixels as different pixels.

A comparison of FIGS. 20 and 23 clearly indicates that light is emitted from pixels 12 toward different viewpoints when the second switchers 32 are in the light transmitting state and the first switchers 31 and the third switchers 33 are in the light blocking state and when the first switchers 31 are in the light transmitting state and the second switchers 32 and the third switchers 33 are in the light blocking state.

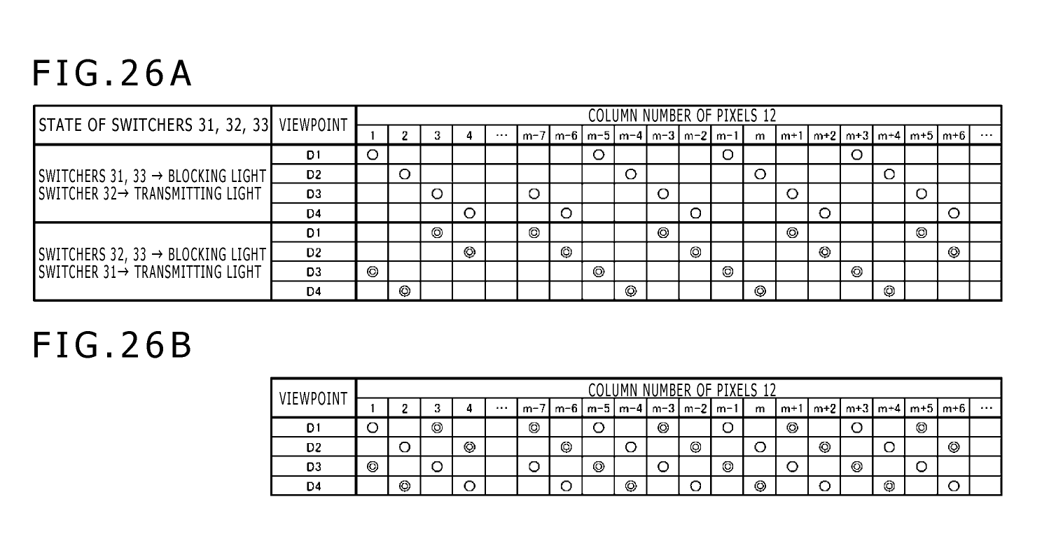

FIG. 26A is a table of column numbers of pixels 12 that make up the images at the viewpoints D1, D2, D3, D4 in the observational areas WA_{L}, WA_{C}, WA_{R} at the time the second switchers 32 are in the light transmitting state and the first switchers 31 and the third switchers 33 are in the light blocking state, and column numbers of pixels 12 that make up the images at the viewpoints D1, D2, D3, D4 in the observational areas WA_{L}, WA_{C}, WA_{R} at the time the first switchers 31 are in the light transmitting state and the second switchers 32 and the third switchers 33 are in the light blocking state, in the image display apparatus 1 according to Embodiment 1. FIG. 26B is a table which is complied from the table shown in FIG. 26A.

As can be seen from FIG. 26A and the above description, when the second switchers 32 are in the light transmitting state and the first switchers 31 and the third switchers 33 are in the light blocking state, the image for the viewpoint D1 is made up by the first column of pixels 12₁ and other columns of pixels 12 which are spaced three columns from each other. Similarly, the image for the viewpoint D2 is made up by the second column of pixels 12₂ and other columns of pixels 12 which are spaced three columns from each other. The image for the viewpoint D3 is made up by the third column of pixels 12₃ and other columns of pixels 12 which are spaced three columns from each other. The image for the viewpoint D4 is made up by the fourth column of pixels 12₄ and other columns of pixels 12 which are spaced three columns from each other.

When the first switchers 31 are in the light transmitting state and the second switchers 32 and the third switchers 33 are in the light blocking state, the image for the viewpoint D1 is made up by the third column of pixels 12₃ and other columns of pixels 12 which are spaced three columns from each other. Similarly, the image for the viewpoint D2 is made up by the fourth column of pixels 12₄ and other columns of pixels 12 which are spaced three columns from each other. The image for the viewpoint D3 is made up by the first column of pixels 12₁ and other columns of pixels 12 which are spaced three columns from each other. The image for the viewpoint D4 is made up by the second column of pixels 12₂ and other columns of pixels 12 which are spaced three columns from each other.

Consequently, a reduction in the resolution of the images for the viewpoints can be lowered by switching between the state in which the first switchers 31 are in the light transmitting state and the second switchers 32 and the third switchers 33 are in the light blocking state, and the state in which the second switchers 32 are in the light transmitting state and the first switchers 31 and the third switchers 33 are in the light blocking state, and also by synchronously switching images displayed on the transmissive display panel 10 to images depending on the viewpoints.

In the above operation of the image display apparatus 1, therefore, as shown in FIG. 26B, the image for the viewpoint D1 is made up by the first column of pixels 12₁ and other columns of pixels 12 which are spaced one column from each other. Similarly, the image for the viewpoint D2 is made up by the second column of pixels 12₂ and other columns of pixels 12 which are spaced one column from each other. The image for the viewpoint D3 is made up by the first column of pixels 12₁ and other columns of pixels 12 which are spaced one column from each other. The image for the viewpoint D4 is made up by the second column of pixels 12₂ and other columns of pixels 12 which are spaced one column from each other.

If the driver 100 does not operate to switch between the state in which the first switchers 31 are in the light transmitting state and the second switchers 32 and the third switchers 33 are in the light blocking state, and the state in which the second switchers 32 are in the light transmitting state and the first switchers 31 and the third switchers 33 are in the light blocking state, then the resolution of the images for the viewpoints is reduced to ¼ of the resolution of the transmissive display panel 10. With the image display apparatus 1 according to Embodiment 1, however, the resolution of the images for the viewpoints is reduced to ½ of the resolution of the transmissive display panel 10. Accordingly, the image display apparatus 1 according to Embodiment 1 is effective to lower the reduction in the resolution of the images for the viewpoints.

The preferred embodiment of the present disclosure has been described above. However, the present disclosure is not limited to the preferred embodiment described above. The arrangement and structure of the image display apparatus and the method of driving the image display apparatus according to the preferred embodiment described above are illustrated by way of example only, and various changes and modifications can be made thereto.

In the description of Embodiment 1, each of the observational areas has four viewpoints. However, the number of viewpoints may be selected depending on the specifications of the image display apparatus 1. For example, the number of viewpoints may be “2” or “6,” and the optical separator 30 may be changed in arrangement accordingly.

In the above description, each column of pixels 12 is associated with a different viewpoint. However, each column of auxiliary pixels may be associated with a different viewpoint. If the pitch of auxiliary pixels is ⅓ of the pitch of pixels, then the distance Z1 shown in FIG. 12 is of about 0.92 [m] and the horizontal pitch RD between the first switchers 31 and the second switchers 32 is of about 0.2 [m] according to the equations (3) and (4).

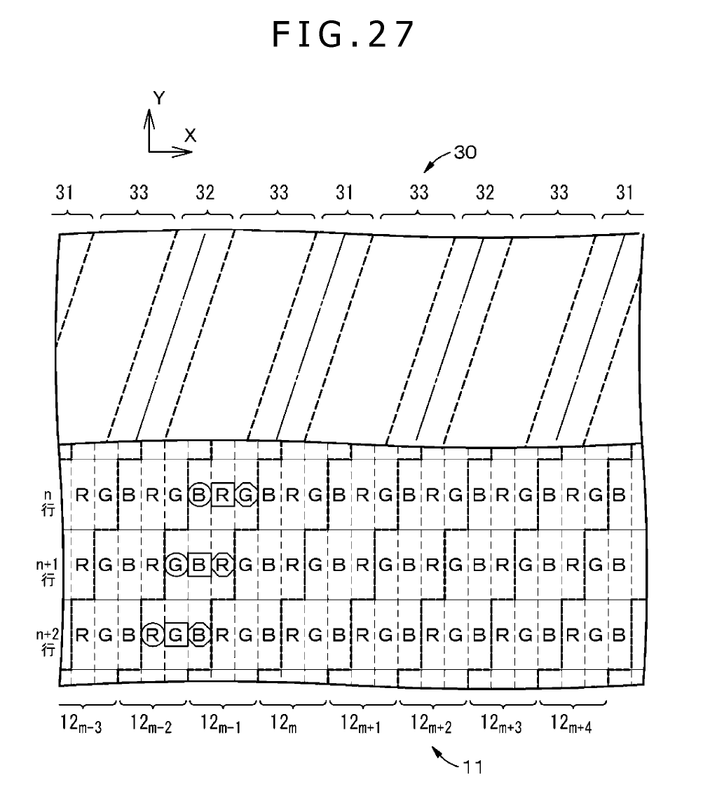

Furthermore, columns of pixels may be selected such that they are shifted one auxiliary pixel in each row, and the switchers 31, 32, 33 may be arranged in alignment with such columns of pixels. The layout of the pixels 12 and the switchers 31, 32, 33 of the optical separator 30 according to such a modification is shown in FIG. 27. In the modification shown in FIG. 27, the switchers 31, 32, 33 of the optical separator 30 are inclined a predetermined angle to the Y-axis which extends along the direction indicated by the arrow Y in FIG. 28. According to another modification shown in FIG. 29, the optical separator 30 includes switchers 31, 32, 33 in the form of pinholes which extend obliquely and hence are inclined a predetermined angle to the Y-axis.

In the matrix of pixels 12 shown in FIG. 27, each oblique array of three auxiliary pixels extending across three rows, i.e., the nth through (n+2)th rows, may make up a pixel. Specifically, auxiliary pixels denoted by R, G, B in circles may make up a pixel, auxiliary pixels denoted by R, G, B in squares may make up a pixel, and auxiliary pixels denoted by R, G, B in octagons may make up a pixel. The pixels thus configured allow the transmissive display panel 10 to have an increased horizontal resolution, though they make the vertical resolution thereof lower.

The present disclosure contains subject matter related to that disclosed in Japanese Priority Patent Application JP 2010-254430 filed in the Japan Patent Office on Nov. 15, 2010, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. An image display apparatus comprising:
a transmissive display panel;
an illuminator configured to illuminate a rear surface of the transmissive display panel;
an optical separator which includes a plurality of switchers capable of switching between a light transmitting state and a light blocking state, for separating an image displayed on the transmissive display panel by bringing one of the switchers into the light transmitting state and the other switchers into the light blocking state; and
a light regulator capable of switching between a light diffusing state and a light transmitting state, wherein
said optical separator is disposed between said transmissive display panel and said illuminator, said light regulator is disposed between said optical separator and said transmissive display panel,
when a plurality of viewpoint images are displayed on said transmissive display panel, said light regulator is brought into the light transmitting state, and
when a single viewpoint image is displayed on said transmissive display panel, said light regulator is brought into the light diffusing state.

2. The image display apparatus according to claim 1, wherein said light regulator includes a diffused liquid crystal material layer which switches between a light transmitting state and a light diffusing state depending on a voltage applied thereto.

3. The image display apparatus according to claim 1, wherein when a single viewpoint image is displayed on said transmissive display panel, all said switchers of said optical separator are brought into said light transmitting state.

4. The image display apparatus according to claim 1, wherein
said switchers of said optical separator include a plurality of first switchers, second switchers, and third switchers which extend substantially vertically and which are juxtaposed horizontally,
said first switchers and said second switchers are alternately disposed horizontally with said third switchers interposed therebetween,
when a plurality of viewpoint images are displayed on said transmissive display panel, said optical separator switches alternately between a state in which said first switchers are in the light transmitting state and said second switchers and said third switchers are in the light blocking state, and a state in which said second switchers are in the light transmitting state and said first switchers and said third switchers are in the light blocking state, and said transmissive display panel synchronously switches between images displayed thereon.

5. An image display apparatus comprising:
a transmissive display panel;
an illuminator;
an optical separator which includes a plurality of switchers capable of switching between a light transmitting state and a light blocking state; and
a light regulator capable of switching between a light diffusing state and a light transmitting state, wherein
said optical separator is disposed between said transmissive display panel and said illuminator,
said light regulator is disposed between said optical separator and said transmissive display panel,
when a plurality of viewpoint images are displayed on said transmissive display panel, said light regulator is brought into the light transmitting state, and
when a single viewpoint image is displayed on said transmissive display panel, said light regulator is brought into the light diffusing state.

6. The image display apparatus according to claim 5, wherein said light regulator includes a diffused liquid crystal material layer which switches between a light transmitting state and a light diffusing state depending on a voltage applied thereto.

7. The image display apparatus according to claim 5, wherein when a single viewpoint image is displayed on said transmissive display panel, all said switchers of said optical separator are brought into said light transmitting state.

8. The image display apparatus according to claim 5, wherein
said switchers of said optical separator include first switchers, second switchers, and third switchers;
said first switchers and said second switchers are alternately disposed horizontally with said third switchers interposed therebetween; and
when a plurality of viewpoint images are displayed on said transmissive display panel, said optical separator switches alternately between a state in which said first switchers are in the light transmitting state and said second switchers and said third switchers are in the light blocking state, and a state in which said second switchers are in the light transmitting state and said first switchers and said third switchers are in the light blocking state.

9. A method of driving an image display apparatus including:
a transmissive display panel,
an illuminator for illuminating a rear surface of the transmissive display panel,
an optical separator which includes a plurality of switchers capable of switching between a light transmitting state and a light blocking state, for separating an image displayed on the transmissive display panel by bringing one of the switchers into the light transmitting state and the other switchers into the light blocking state, and
a light regulator capable of switching between a light diffusing state and a light transmitting state, wherein
said optical separator is disposed between said transmissive display panel and said illuminator, and
said light regulator is disposed between said optical separator and said transmissive display panel,
said method comprising:
bringing said light regulator into the light transmitting state when a plurality of viewpoint images are displayed on said transmissive display panel; and
bringing said light regulator into the light diffusing state when a single viewpoint image is displayed on said transmissive display panel.
